(19) United States
(12) Patent Application Publication
(10) Pub. No.: US 2016/0224502 A1
(43) Pub. Date: Aug. 4, 2016

(54) Synchronization in a Computing System with Multi-Core Processing Devices

(71) Applicant: The Intellisis Corporation, San Diego, CA (US)

(72) Inventors: Douglas A. PALMER, San Diego, CA (US); Andrew J. WHITE, San Diego, CA (US); Mark A. DOYLE, San Diego, CA (US); Doug B. MEYER, San Diego, CA (US)

(73) Assignee: The Intellisis Corporation, San Diego, CA (US)

(21) Appl. No.: 14/608,693

(22) Filed: Jan. 29, 2015

(51) Int. Cl. G06F 13/40; G06F 9/48

(52) U.S. Cl. CPC G06F 13/4059; G06F 9/4881

(57) ABSTRACT

Systems and methods for synchronization within a processing system use events and/or signals to indicate whether certain buffers (or other system components) are idle. New tasks may be assigned to individual processing elements once they are deemed idle by virtue of certain buffers or components being idle.

### FIELD OF THE DISCLOSURE

The invention relates to synchronization within a computing system that contains a plurality of multi-core processing devices, and, in particular, synchronized processing of multiple computing resources of the multi-core processing devices by virtue of signaling of events, status, and/or activity related to buffers used within the multi-core processing devices to accommodate communication.

### BACKGROUND

Information-processing systems are computing systems that process electronic and/or digital information. Typical information-processing system may include multiple processing elements, such as multiple single core computer processors or one or more multi-core computer processors capable of concurrent and/or independent operation. Such systems may be referred to as multi-processor or multi-core processing systems.

Synchronization mechanisms in such systems commonly include interrupts and/or exceptions implemented in hardware, software, and/or combinations thereof. When multiple processing elements, such as multiple processors or multiple processing cores execute in parallel to process data for one computation process, the interrupts and/or exceptions do not provide adequate synchronization between the processing elements. Therefore, there is a need in the art for a synchronization mechanism for a plurality of processing elements of a computing system that may be able to detect when a prescribed set of operations is complete and the system has become idle, that is independent of the number of operations involved and/or the specific length of time taken by each of those operations.

### SUMMARY

The present disclosure provides systems, methods and apparatuses for synchronization of processing elements in a computing system. In one aspect of the disclosure, a processing device may be provided. The processing device may comprise a plurality of processing elements each configured to generate events, a plurality of buffers for communicating data to and from the plurality of processing elements, at least one programmable register to hold a predefined time limit, at least one timing register for counting a time since a last activity in one or more buffers, and at least one event register to hold an event flag. The event flag may be set to a signaled state to signal that an event has taken place when the time counted in the at least one timing register reaches the predefined time limit.

In another aspect of the disclosure, a method of operating a processing device that has a plurality processing elements configured to support parallel processing may be provided. The method may comprise loading one or more tasks to be executed in two or more processing elements of the plurality of processing elements, executing one or more tasks on the two or more processing elements and monitoring buffers associated with the two or more processing elements. The monitored buffers may be used to communicate the one or more tasks to the two or more processing elements. The method may further comprise determining states of the two or more processing elements based on the monitored buffer activities and setting a first event flag after no activity is monitored in at least one of the two or more processing elements based on the determined states.

In yet another aspect of the disclosure, a computing system may be provided. The computing system may comprise a plurality of processing device and a host. Each processing device may comprise a plurality of processing elements each configured to generate events, a plurality of buffers for communicating data to and from the plurality of processing elements, at least one programmable register to hold a predefined time limit, at least one timing register for counting a time since a last activity in one or more buffers and at least one event register to hold an event flag. The event flag may be set to a signaled state to signal that an event has taken place when the time counted in the at least one timing register reaches the predefined time limit. The host may be configured to assign one or more tasks to at least a subset of processing elements of the plurality of processing devices, load to one or more tasks to the assigned processing elements to be executed thereon, monitor event flag(s) associated with the assigned processing elements and determine whether one or more processing devices of the plurality of processing devices have entered an idle state.

In yet another aspect, the present disclosure may provide a method of operating a computing system that may have a plurality of processing devices and each processing device may have a plurality of processing elements configured to support parallel processing. The method may comprise assigning one or more tasks to at least a subset of processing elements of the plurality of processing devices, loading one or more tasks to the assigned processing elements, executing the one or more tasks on the assigned processing elements and monitoring buffers associated with the assigned processing elements. The monitored buffers may be used to communicate the one or more tasks to the two or more processing elements. The method may further comprise determining states of the assigned processing elements based on the monitored buffer activities and setting a first event flag after no activity is monitored in at least one of the two or more processing elements based on the determined states.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1A is a block diagram of an exemplary computing system according to the present disclosure.

FIG. 1B is a block diagram of an exemplary processing device according to the present disclosure.

FIG. 2A is a block diagram of topology of connections of an exemplary computing system according to the present disclosure.

FIG. 2B is a block diagram of topology of connections of another exemplary computing system according to the present disclosure.

FIG. 3A is a block diagram of an exemplary cluster according to the present disclosure.

FIG. 3B is a block diagram of an exemplary super cluster according to the present disclosure.

FIG. 4 is a block diagram of an exemplary processing engine according to the present disclosure.

FIG. 5 is a block diagram of an exemplary packet according to the present disclosure.

FIG. 6 is a flow diagram showing an exemplary process of addressing a computing resource using a packet according to the present disclosure.

FIG. 7 is a block diagram of an exemplary processing device according to the present disclosure.

FIG. 8 is a block diagram for an exemplary cluster according to the present disclosure.

FIG. 9 illustrates a computing system configured to synchronize processing elements according to the present disclosure.

FIGS. 10-11 illustrate methods for synchronizing processing engines according to the present disclosure.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order to avoid unnecessarily obscuring the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

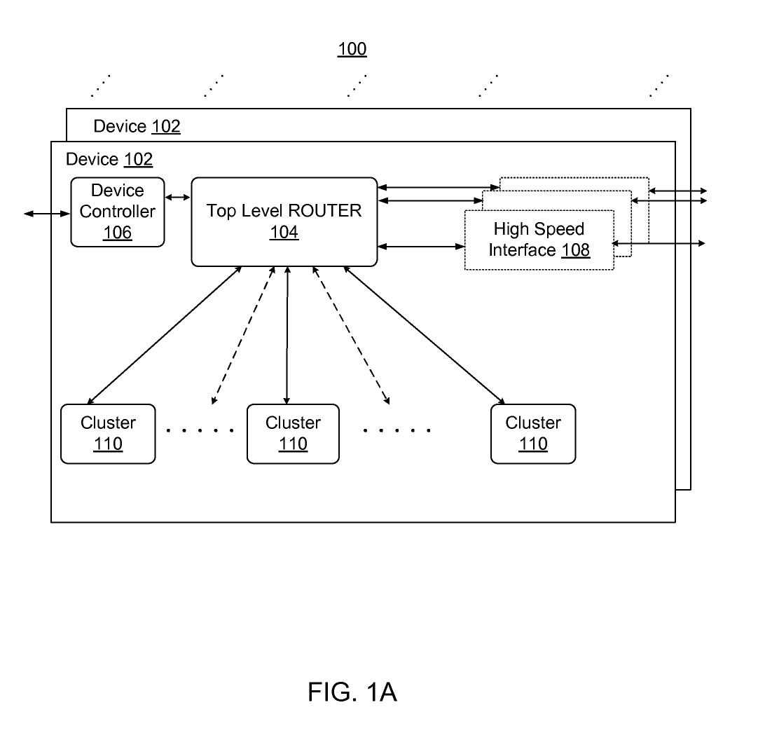

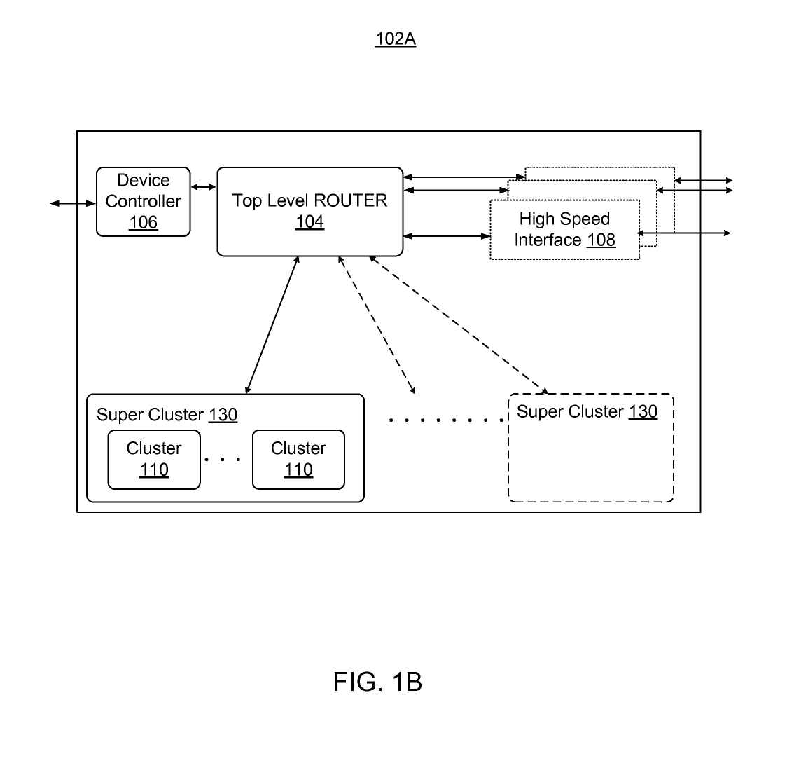

FIG. 1A shows an exemplary computing system 100 according to the present disclosure. The computing system 100 may comprise at least one processing device 102. A typical computing system 100, however, may comprise a plurality of processing devices 102. Each processing device 102, which may also be referred to as device 102, may comprise a router 104, a device controller 106, a plurality of high speed interfaces 108 and a plurality of clusters 110. The router 104 may also be referred to as a top level router or a level one router. Each cluster 110 may comprise a plurality of processing engines to provide computational capabilities for the computing system 100. The high speed interfaces 108 may comprise communication ports to communicate data outside of the device 102, for example, to other devices 102 of the computing system 100 and/or interfaces to other computing systems. Unless specifically expressed otherwise, data as used herein may refer to both program code and pieces of information upon which the program code operates.

In some implementations, the processing device 102 may include 2, 4, 8, 16, 32 or another number of high speed interfaces 108. Each high speed interface 108 may implement a physical communication protocol. In one non-limiting example, each high speed interface 108 may implement the media access control (MAC) protocol, and thus may have a unique MAC address associated with it. The physical communication may be implemented in a known communication technology, for example, Gigabit Ethernet, or any other existing or future-developed communication technology. In one non-limiting example, each high speed interface 108 may implement bi-directional high-speed serial ports, such as 10 Giga bits per second (Gbps) serial ports. Two processing devices 102 implementing such high speed interfaces 108 may be directly coupled via one pair or multiple pairs of the high speed interfaces 108, with each pair comprising one high speed interface 108 on one processing device 102 and another high speed interface 108 on the other processing device 102.

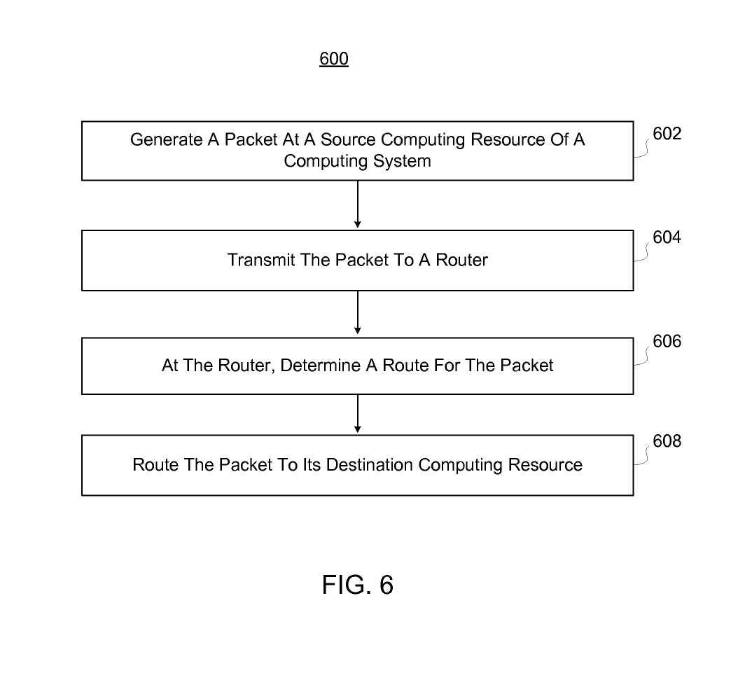

Data communication between different computing resources of the computing system 100 may be implemented using routable packets. The computing resources may comprise device level resources such as a device controller 106, cluster level resources such as a cluster controller or cluster memory controller, and/or the processing engine level resources such as individual processing engines and/or individual processing engine memory controllers. An exemplary packet 140 according to the present disclosure is shown in FIG. 5. The packet 140 may comprise a header 142 and a payload 144. The header 142 may include a routable destination address for the packet 140. The router 104 may be a top-most router configured to route packets on each processing device 102. The router 104 may be a programmable router. That is, the routing information used by the router 104 may be programmed and updated. In one non-limiting embodiment, the router 104 may be implemented using an address resolution table (ART) or Look-up table (LUT) to route any packet it receives on the high speed interfaces 108, or any of the internal interfaces interfacing the device controller 106 or clusters 110. For example, depending on the destination address, a packet 140 received from one cluster 110 may be routed to a different cluster 110 on the same processing device 102, or to a different processing device 102; and a packet 140 received from one high speed interface 108 may be routed to a cluster 110 on the processing device or to a different processing device 102.

The device controller 106 may control the operation of the processing device 102 from power on through power down. The device controller 106 may comprise a device controller processor, one or more registers and a device controller memory space. The device controller processor may be any existing or future-developed microcontroller. In one embodiment, for example, an ARM® Cortex M0 microcontroller may be used for its small footprint and low power consumption. In another embodiment, a bigger and more powerful microcontroller may be chosen if needed. The one or more registers may include one to hold a device identifier (DEVID) for the processing device 102 after the processing device 102 is powered up. The DEVID may be used to uniquely identify the processing device 102 in the computing system 100. In one non-limiting embodiment, the DEVID may be loaded on system start from a non-volatile storage, for example, a non-volatile internal storage on the processing device 102 or a non-volatile external storage. The device controller memory space may include both read-only memory (ROM) and random access memory (RAM). In one non-limiting embodiment, the ROM may store bootloader code that during a system start may be executed to initialize the processing device 102 and load the remainder of the boot code through a bus from outside of the device controller 106. The instructions for the device controller processor, also referred to as the firmware, may reside in the RAM after they are loaded during the system start.

The registers and device controller memory space of the device controller 106 may be read and written to by computing resources of the computing system 100 using packets. That is, they are addressable using packets. As used herein, the term “memory” may refer to RAM, SRAM, DRAM, eDRAM, SDRAM, volatile memory, non-volatile memory, and/or other types of electronic memory. For example, the header of a packet may include a destination address such as DEVID:PADDR, of which the DEVID may identify the processing device 102 and the PADDR may be an address for a register of the device controller 106 or a memory location of the device controller memory space of a processing device 102. In some embodiments, a packet directed to the device controller 106 may have a packet operation code, which may be referred to as packet opcode or just opcode to indicate what operation needs to be performed for the packet. For example, the packet operation code may indicate reading from or writing to the storage location pointed to by PADDR. It should be noted that the device controller 106 may also send packets in addition to receiving them. The packets sent by the device controller 106 may be self-initiated or in response to a received packet (e.g., a read request). Self-initiated packets may include for example, reporting status information, requesting data, etc.

In one embodiment, a plurality of clusters 110 on a processing device 102 may be grouped together. FIG. 1B shows a block diagram of another exemplary processing device 102A according to the present disclosure. The exemplary processing device 102A is one particular embodiment of the processing device 102. Therefore, the processing device 102 referred to in the present disclosure may include any embodiments of the processing device 102, including the exemplary processing device 102A. As shown on FIG. 1B, a plurality of clusters 110 may be grouped together to form a super cluster 130 and an exemplary processing device 102A may comprise a plurality of such super clusters 130. In one embodiment, a processing device 102 may include 2, 4, 8, 16, 32 or another number of clusters 110, without further grouping the clusters 110 into super clusters. In another embodiment, a processing device 102 may include 2, 4, 8, 16, 32 or another number of super clusters 130 and each super cluster 130 may comprise a plurality of clusters.

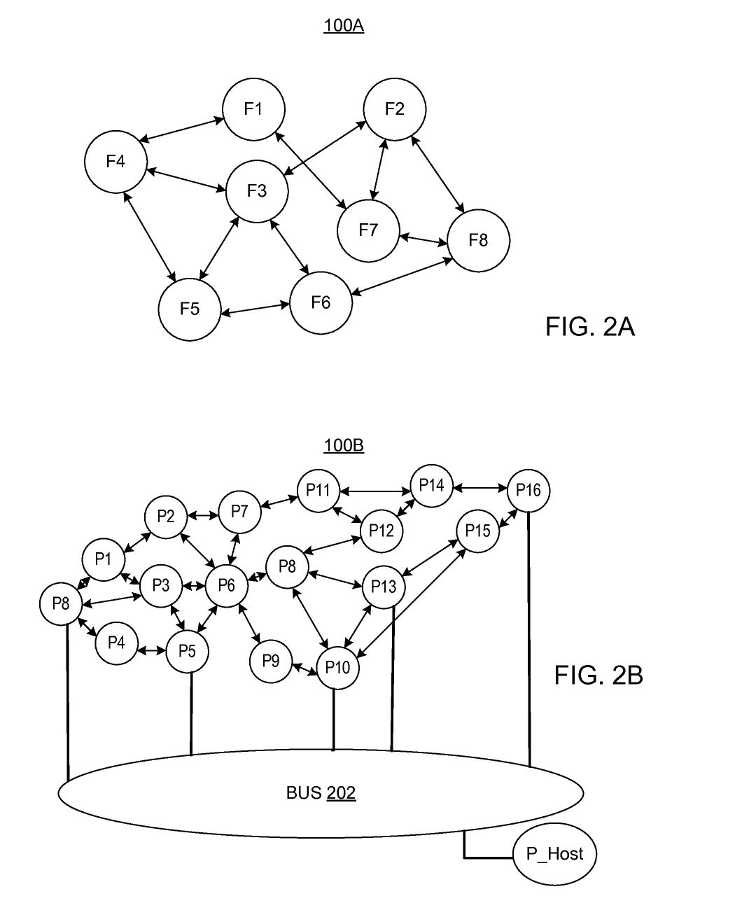

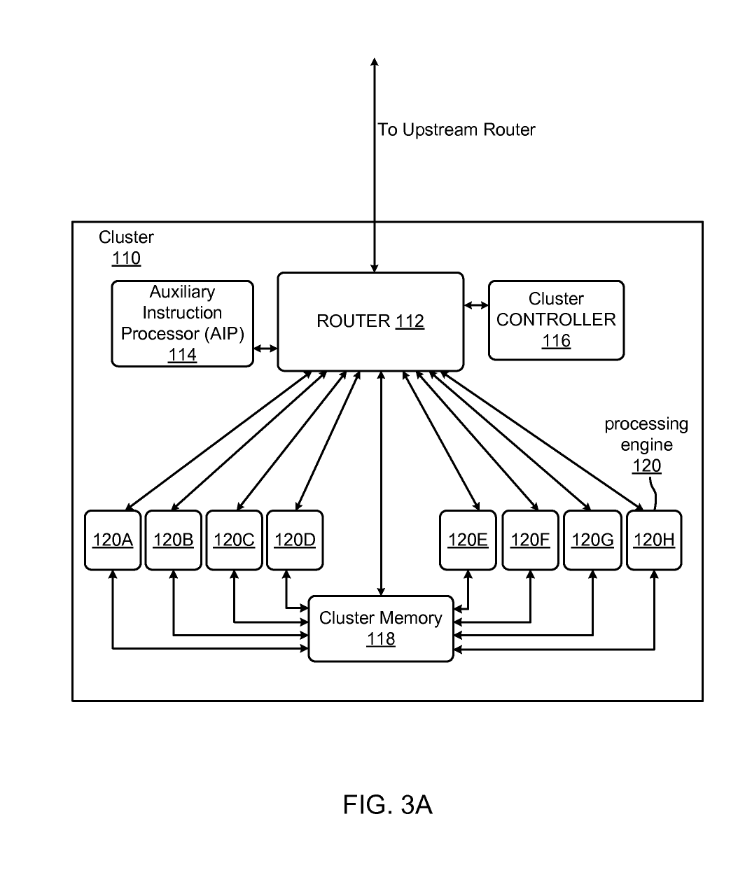

FIG. 2A shows a block diagram of an exemplary computing system 100A according to the present disclosure. The computing system 100A may be one exemplary embodiment of the computing system 100 of FIG. 1A. The computing system 100A may comprise a plurality of processing devices 102 designated as F1, F2, F3, F4, F5, F6, F7 and F8. As shown in FIG. 2A, each processing device 102 may be directly coupled to one or more other processing devices 102. For example, F4 may be directly coupled to F1, F3 and F5; and F7 may be directly coupled to F1, F2 and F8. Within computing system 100A, one of the processing devices 102 may function as a host for the whole computing system 100A. The host may have a unique device ID that every processing devices 102 in the computing system 100A recognizes as the host. For example, any processing devices 102 may be designated as the host for the computing system 100A. In one non-limiting example, F1 may be designated as the host and the device ID for F1 may be set as the unique device ID for the host.

In another embodiment, the host may be a computing device of a different type, such as a computer processor known in the art (for example, an ARM® Cortex or Intel® x86 processor) or any other existing or future-developed processors. In this embodiment, the host may communicate with the rest of the system 100A through a communication interface, which may represent itself to the rest of the system 100A as the host by having a device ID for the host.

The computing system 100A may implement any appropriate techniques to set the DEVIDs, including the unique DEVID for the host, to the respective processing devices 102 of the computing system 100A. In one exemplary embodiment, the DEVIDs may be stored in the ROM of the respective device controller 106 for each processing devices 102 and loaded into a register for the device controller 106 at power up. In another embodiment, the DEVIDs may be loaded from an external storage. In such an embodiment, the assignments of DEVIDs may be performed offline, and may be changed offline from time to time or as appropriate. Thus, the DEVIDs for one or more processing devices 102 may be different each time the computing system 100A initializes. Moreover, the DEVIDs stored in the registers for each device controller 106 may be changed at runtime. This runtime change may be controlled by the host of the computing system 100A. For example, after the initialization of the computing system 100A, which may load the pre-configured DEVIDs from ROM or external storage, the host of the computing system 100A may reconfigure the computing system 100A and assign different DEVIDs to the processing devices 102 in the computing system 100A to overwrite the initial DEVIDs in the registers of the device controllers 106.

FIG. 2B is a block diagram of a topology of another exemplary system 100B according to the present disclosure. The computing system 100B may be another exemplary embodiment of the computing system 100 of FIG. 1 and may comprise a plurality of processing devices 102 (designated as P1 through P16 on FIG. 2B), a bus 202 and a processing device P_Host. Each processing device of P1 through P16 may be directly coupled to another processing device of P1 through P16 by a direct link between them. At least one of the processing devices P1 through P16 may be coupled to the bus 202. As shown in FIG. 2B, the processing devices P8, P5, P10, P13, P15 and P16 may be coupled to the bus 202. The processing device P_Host may be coupled to the bus 202 and may be designated as the host for the computing system 100B. In the exemplary system 100B, the host may be a computer processor known in the art (for example, an ARM® Cortex or Intel® x86 processor) or any other existing or future-developed processors. The host may communicate with the rest of the system 100B through a communication interface coupled to the bus and may represent itself to the rest of the system 100B as the host by having a device ID for the host.

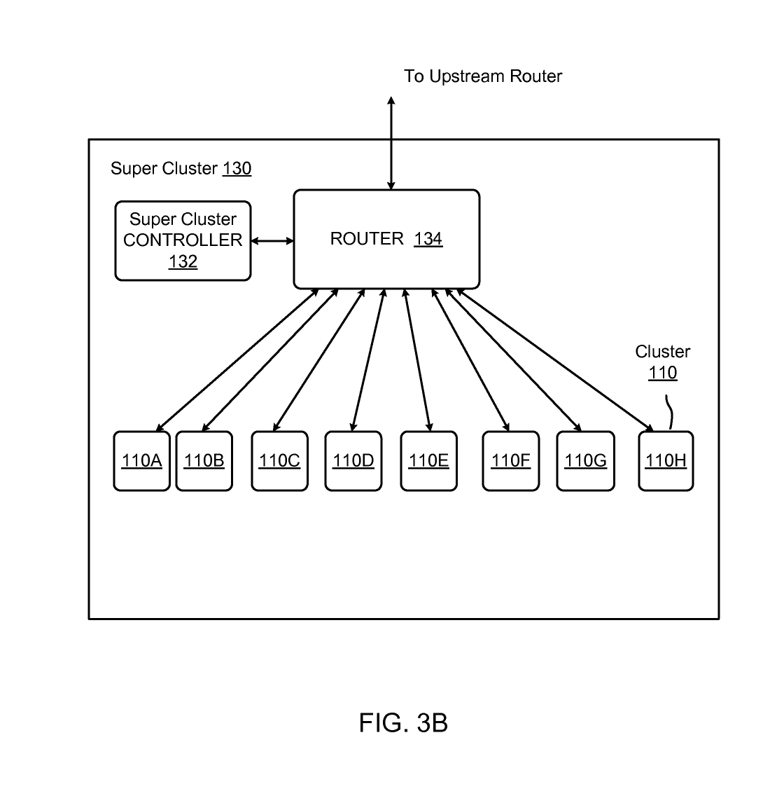

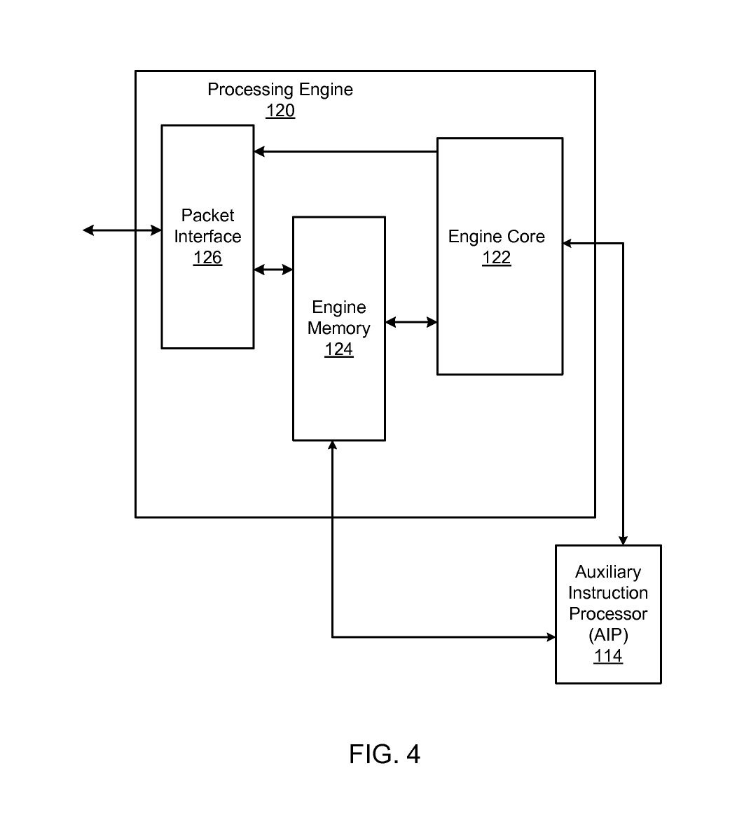

FIG. 3A shows a block diagram of an exemplary cluster 110 according to the present disclosure. The exemplary cluster 110 may comprise a router 112, a cluster controller 116, an auxiliary instruction processor (AIP) 114, a cluster memory 118 and a plurality of processing engines 120. The router 112 may be coupled to an upstream router to provide interconnection between the upstream router and the cluster 110. The upstream router may be, for example, the router 104 of the processing device 102 if the cluster 110 is not part of a super cluster 130.

The exemplary operations to be performed by the router 112 may include receiving a packet destined for a resource within the cluster 110 from outside the cluster 110 and/or transmitting a packet originating within the cluster 110 destined for a resource inside or outside the cluster 110. A resource within the cluster 110 may be, for example, the cluster memory 118 or any of the processing engines 120 within the cluster 110. A resource outside the cluster 110 may be, for example, a resource in another cluster 110 of the computer device 102, the device controller 106 of the processing device 102, or a resource on another processing device 102. In some embodiments, the router 112 may also transmit a packet to the router 104 even if the packet may target a resource within itself. In one embodiment, the router 104 may implement a loopback path to send the packet back to the originating cluster 110 if the destination resource is within the cluster 110.

The cluster controller 116 may send packets, for example, as a response to a read request, or as unsolicited data sent by hardware for error or status report. The cluster controller 116 may also receive packets, for example, packets with opcodes to read or write data. In one embodiment, the cluster controller 116 may be any existing or future-developed microcontroller, for example, one of the ARM® Cortex-M microcontroller and may comprise one or more cluster control registers (CCRs) that provide configuration and control of the cluster 110. In another embodiment, instead of using a microcontroller, the cluster controller 116 may be custom made to implement any functionalities for handling packets and controlling operation of the router 112. In such an embodiment, the functionalities may be referred to as custom logic and may be implemented, for example, by FPGA or other specialized circuitry. Regardless of whether it is a microcontroller or implemented by custom logic, the cluster controller 116 may implement a fixed-purpose state machine encapsulating packets and memory access to the CCRs.

Each cluster memory 118 may be part of the overall addressable memory of the computing system 100. That is, the addressable memory of the computing system 100 may include the cluster memories 118 of all clusters of all devices 102 of the computing system 100. The cluster memory 118 may be a part of the main memory shared by the computing system 100. In some embodiments, any memory location within the cluster memory 118 may be addressed by any processing engine within the computing system 100 by a physical address. The physical address may be a combination of the DEVID, a cluster identifier (CLSID) and a physical address location (PADDR) within the cluster memory 118, which may be formed as a string of bits, such as, for example, DEVID:CLSID:PADDR. The DEVID may be associated with the device controller 106 as described above and the CLSID may be a unique identifier to uniquely identify the cluster 110 within the local processing device 102. It should be noted that in at least some embodiments, each register of the cluster controller 116 may also be assigned a physical address (PADDR). Therefore, the physical address DEVID:CLSID:PADDR may also be used to address a register of the cluster controller 116, in which PADDR may be an address assigned to the register of the cluster controller 116.

In some other embodiments, any memory location within the cluster memory 118 may be addressed by any processing engine within the computing system 100 by a virtual address. The virtual address may be a combination of a DEVID, a CLSID and a virtual address location (ADDR), which may be formed as a string of bits, such as, for example, DEVID:CLSID:ADDR. The DEVID and CLSID in the virtual address may be the same as in the physical addresses.

In one embodiment, the width of ADDR may be specified by system configuration. For example, the width of ADDR may be loaded into a storage location convenient to the cluster memory 118 during system start and/or changed from time to time when the computing system 100 performs a system configuration. To convert the virtual address to a physical address, the value of ADDR may be added to a base physical address value (BASE). The BASE may also be specified by system configuration as the width of ADDR and stored in a location convenient to a memory controller of the cluster memory 118. In one example, the width of ADDR may be stored in a first register and the BASE may be stored in a second register in the memory controller. Thus, the virtual address DEVID:CLSID:ADDR may be converted to a physical address as DEVID:CLSID:ADDR+BASE. Note that the result of ADDR+BASE has the same width as the longer of the two.

The address in the computing system 100 may be 8 bits, 16 bits, 32 bits, 64 bits, or any other number of bits wide. In one non-limiting example, the address may be 32 bits wide. The DEVID may be 10, 15, 20, 25 or any other number of bits wide. The width of the DEVID may be chosen based on the size of the computing system 100, for example, how many processing devices 102 the computing system 100 has or may be designed to have. In one non-limiting example, the DEVID may be 20 bits wide and the computing system 100 using this width of DEVID may contain up to 2²⁰ processing devices 102. The width of the CLSID may be chosen based on how many clusters 110 the processing device 102 may be designed to have. For example, the CLSID may be 3, 4, 5, 6, 7, 8 bits or any other number of bits wide. In one non-limiting example, the CLSID may be 5 bits wide and the processing device 102 using this width of CLSID may contain up to 2⁵ clusters. The width of the PADDR for the cluster level may be 20, 30 or any other number of bits. In one non-limiting example, the PADDR for the cluster level may be 27 bits and the cluster 110 using this width of PADDR may contain up to 2²⁷ memory locations and/or addressable registers. Therefore, in some embodiments, if the DEVID may be 20 bits wide, CLSID may be 5 bits and PADDR may have a width of 27 bits, a physical address DEVID:CLSID:PADDR or DEVID:CLSID:ADDR+BASE may be 52 bits.

For performing the virtual to physical memory conversion, the first register (ADDR register) may have 4, 5, 6, 7 bits or any other number of bits. In one non-limiting example, the first register may be 5 bits wide. If the value of the 5 bits register is four (4), the width of ADDR may be 4 bits; and if the value of 5 bits register is eight (8), the width of ADDR will be 8 bits. Regardless of ADDR being 4 bits or 8 bits wide, if the PADDR for the cluster level may be 27 bits then BASE may be 27 bits, and the result of ADDR+BASE may still be a 27 bits physical address within the cluster memory 118.

FIG. 3A shows that a cluster 110 may comprise one cluster memory 118. In another embodiment, a cluster 110 may comprise a plurality of cluster memories 118 that each may comprise a memory controller and a plurality of memory banks, respectively. Moreover, in yet another embodiment, a cluster 110 may comprise a plurality of cluster memories 118 and these cluster memories 118 may be connected together via a router that may be downstream of the router 112.

The AIP 114 may be a special processing engine shared by all processing engines 120 of one cluster 110. In one example, the AIP 114 may be implemented as a coprocessor to the processing engines 120. For example, the AIP 114 may implement less commonly used instructions such as some floating point arithmetic, including but not limited to, one or more of addition, subtraction, multiplication, division and square root, etc. As shown in FIG. 3A, the AIP 114 may be coupled to the router 112 directly and may be configured to send and receive packets via the router 112. As a coprocessor to the processing engines 120 within the same cluster 110, although not shown in FIG. 3A, the AIP 114 may also be coupled to each processing engines 120 within the same cluster 110 directly. In one embodiment, a bus shared by all the processing engines 120 within the same cluster 110 may be used for communication between the AIP 114 and all the processing engines 120 within the same cluster 110. In another embodiment, a multiplexer may be used to control communication between the AIP 114 and all the processing engines 120 within the same cluster 110. In yet another embodiment, a multiplexer may be used to control access to the bus shared by all the processing engines 120 within the same cluster 110 for communication with the AIP 114.

The grouping of the processing engines 120 on a computing device 102 may have a hierarchy with multiple levels. For example, multiple clusters 110 may be grouped together to form a super cluster. FIG. 3B is a block diagram of an exemplary super cluster 130 according to the present disclosure. As shown on FIG. 3B, a plurality of clusters 110A through 110H may be grouped into an exemplary super cluster 130. Although 8 clusters are shown in the exemplary super cluster 130 on FIG. 3B, the exemplary super cluster 130 may comprise 2, 4, 8, 16, 32 or another number of clusters 110. The exemplary super cluster 130 may comprise a router 134 and a super cluster controller 132, in addition to the plurality of clusters 110. The router 134 may be configured to route packets among the clusters 110 and the super cluster controller 132 within the super cluster 130, and to and from resources outside the super cluster 130 via a link to an upstream router. In an embodiment in which the super cluster 130 may be used in a processing device 102A, the upstream router for the router 134 may be the top level router 104 of the processing device 102A and the router 134 may be an upstream router for the router 112 within the cluster 110. In one embodiment, the super cluster controller 132 may implement CCRs, may be configured to receive and send packets, and may implement a fixed-purpose state machine encapsulating packets and memory access to the CCRs, and the super cluster controller 132 may be implemented similar to the cluster controller 116. In another embodiment, the super cluster 130 may be implemented with just the router 134 and may not have a super cluster controller 132.

An exemplary cluster 110 according to the present disclosure may include 2, 4, 8, 16, 32 or another number of processing engines 120. FIG. 3A shows an example of a plurality of processing engines 120 been grouped into a cluster 110 and FIG. 3B shows an example of a plurality of clusters 110 been grouped into a super cluster 130. Grouping of processing engines is not limited to clusters or super clusters. In one embodiment, more than two levels of grouping may be implemented and each level may have its own router and controller.

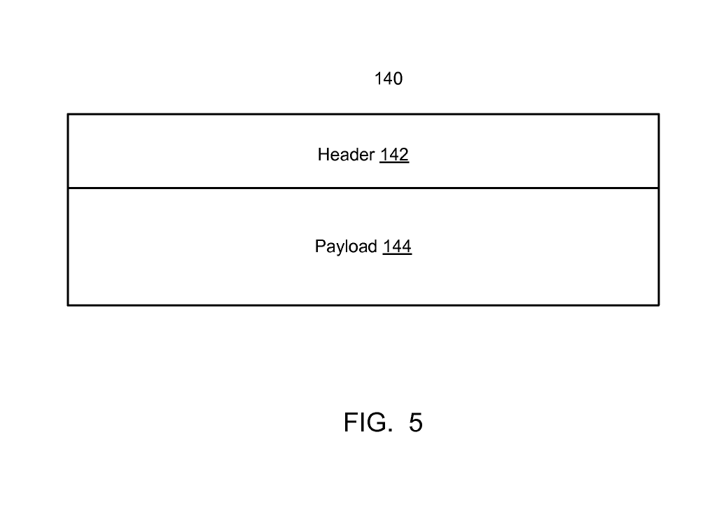

FIG. 4 shows a block diagram of an exemplary processing engine 120 according to the present disclosure. As shown in FIG. 4, the processing engine 120 may comprise an engine core 122, an engine memory 124 and a packet interface 126. The processing engine 120 may be coupled to an AIP 114. As described herein, the AIP 114 may be shared by all processing engines 120 within a cluster 110. The processing core 122 may be a central processing unit (CPU) with an instruction set and may implement some or all features of modern CPUs, such as, for example, a multi-stage instruction pipeline, one or more arithmetic logic units (ALUs), a floating point unit (FPU) or any other existing or future-developed CPU technology. The instruction set may comprise one instruction set for the ALU to perform arithmetic and logic operations, and another instruction set for the FPU to perform floating point operations. In one embodiment, the FPU may be a completely separate execution unit containing a multi-stage, single-precision floating point pipeline. When an FPU instruction reaches the instruction pipeline of the processing engine 120, the instruction and its source operand(s) may be dispatched to the FPU.

The instructions of the instruction set may implement the arithmetic and logic operations and the floating point operations, such as those in the INTEL® x86 instruction set, using a syntax similar or different from the x86 instructions. In some embodiments, the instruction set may include customized instructions. For example, one or more instructions may be implemented according to the features of the computing system 100. In one example, one or more instructions may cause the processing engine executing the instructions to generate packets directly with system wide addressing. In another example, one or more instructions may have a memory address located anywhere in the computing system 100 as an operand. In such an example, a memory controller of the processing engine executing the instruction may generate packets according to the memory address being accessed.

The engine memory 124 may comprise a program memory, a register file comprising one or more general purpose registers, one or more special registers and one or more events registers. The program memory may be a physical memory for storing instructions to be executed by the processing core 122 and data to be operated upon by the instructions. In some embodiments, portions of the program memory may be disabled and powered down for energy savings. For example, a top half or a bottom half of the program memory may be disabled to save energy when executing a program small enough that less than half of the storage may be needed. The size of the program memory may be 1 thousand (1K), 2K, 3K, 4K, or any other number of storage units. The register file may comprise 128, 256, 512, 1024, or any other number of storage units. In one non-limiting example, the storage unit may be 32-bit wide, which may be referred to as a longword, and the program memory may comprise 2K 32-bit longwords and the register file may comprise 256 32-bit registers.

The register file may comprise one or more general purpose registers for the processing core 122. The general purpose registers may serve functions that are similar or identical to the general purpose registers of an x86 architecture CPU.

The special registers may be used for configuration, control and/or status. Exemplary special registers may include one or more of the following registers: a program counter, which may be used to point to the program memory address where the next instruction to be executed by the processing core 122 is stored; and a device identifier (DEVID) register storing the DEVID of the processing device 102.

In one exemplary embodiment, the register file may be implemented in two banks—one bank for odd addresses and one bank for even addresses—to permit fast access during operand fetching and storing. The even and odd banks may be selected based on the least-significant bit of the register address for if the computing system 100 is implemented in little endian or on the most-significant bit of the register address if the computing system 100 is implemented in big-endian.

The engine memory 124 may be part of the addressable memory space of the computing system 100. That is, any storage location of the program memory, any general purpose register of the register file, any special register of the plurality of special registers and any event register of the plurality of events registers may be assigned a memory address PADDR. Each processing engine 120 on a processing device 102 may be assigned an engine identifier (ENGINE ID), therefore, to access the engine memory 124, any addressable location of the engine memory 124 may be addressed by DEVID:CLSID:ENGINE ID:PADDR. In one embodiment, a packet addressed to an engine level memory location may include an address formed as DEVID:CLSID:ENGINE ID:EVENTS:PADDR, in which EVENTS may be one or more bits to set event flags in the destination processing engine 120. It should be noted that when the address is formed as such, the events need not form part of the physical address, which is still DEVID:CLSID:ENGINE ID:PADDR. In this form, the events bits may identify one or more event registers to be set but these events bits may be separate from the physical address being accessed.

The packet interface 126 may comprise a communication port for communicating packets of data. The communication port may be coupled to the router 112 and the cluster memory 118 of the local cluster. For any received packets, the packet interface 126 may directly pass them through to the engine memory 124. In some embodiments, a processing device 102 may implement two mechanisms to send a data packet to a processing engine 120. For example, a first mechanism may use a data packet with a read or write packet opcode. This data packet may be delivered to the packet interface 126 and handled by the packet interface 126 according to the packet opcode. The packet interface 126 may comprise a buffer to hold a plurality of storage units, for example, 1K, 2K, 4K, or 8K or any other number. In a second mechanism, the engine memory 124 may further comprise a register region to provide a write-only, inbound data interface, which may be referred to a mailbox. In one embodiment, the mailbox may comprise two storage units that each can hold one packet at a time. The processing engine 120 may have a event flag, which may be set when a packet has arrived at the mailbox to alert the processing engine 120 to retrieve and process the arrived packet. When this packet is being processed, another packet may be received in the other storage unit but any subsequent packets may be buffered at the sender, for example, the router 112 or the cluster memory 118, or any intermediate buffers.

In various embodiments, data request and delivery between different computing resources of the computing system 100 may be implemented by packets. FIG. 5 illustrates a block diagram of an exemplary packet 140 according to the present disclosure. As shown in FIG. 5, the packet 140 may comprise a header 142 and an optional payload 144. The header 142 may comprise a single address field, a packet opcode (POP) field and a size field. The single address field may indicate the address of the destination computing resource of the packet, which may be, for example, an address at a device controller level such as DEVID:PADDR, an address at a cluster level such as a physical address DEVID:CLSID:PADDR or a virtual address DEVID:CLSID:ADDR, or an address at a processing engine level such as DEVID:CLSID:ENGINE ID:PADDR or DEVID:CLSID:ENGINE ID:EVENTS:PADDR. The POP field may include a code to indicate an operation to be performed by the destination computing resource. Exemplary operations in the POP field may include read (to read data from the destination) and write (to write data (e.g., in the payload 144) to the destination).

In some embodiments, the exemplary operations in the POP field may further include bulk data transfer. For example, certain computing resources may implement a direct memory access (DMA) feature. Exemplary computing resources that implement DMA may include a cluster memory controller of each cluster memory 118, a memory controller of each engine memory 124, and a memory controller of each device controller 106. Any two computing resources that implemented the DMA may perform bulk data transfer between them using packets with a packet opcode for bulk data transfer.

In addition to bulk data transfer, in some embodiments, the exemplary operations in the POP field may further include transmission of unsolicited data. For example, any computing resource may generate a status report or incur an error during operation, the status or error may be reported to a destination using a packet with a packet opcode indicating that the payload 144 contains the source computing resource and the status or error data.

The POP field may be 2, 3, 4, 5 or any other number of bits wide. In some embodiments, the width of the POP field may be selected depending on the number of operations defined for packets in the computing system 100. Also, in some embodiments, a packet opcode value can have different meaning based on the type of the destination computer resources that receives it. By way of example and not limitation, for a three-bit POP field, a value 001 may be defined as a read operation for a processing engine 120 but a write operation for a cluster memory 118.

In some embodiments, the header 142 may further comprise an addressing mode field and an addressing level field. The addressing mode field may contain a value to indicate whether the single address field contains a physical address or a virtual address that may need to be converted to a physical address at a destination. The addressing level field may contain a value to indicate whether the destination is at a device, cluster memory or processing engine level.

The payload 144 of the packet 140 is optional. If a particular packet 140 does not include a payload 144, the size field of the header 142 may have a value of zero. In some embodiments, the payload 144 of the packet 140 may contain a return address. For example, if a packet is a read request, the return address for any data to be read may be contained in the payload 144.

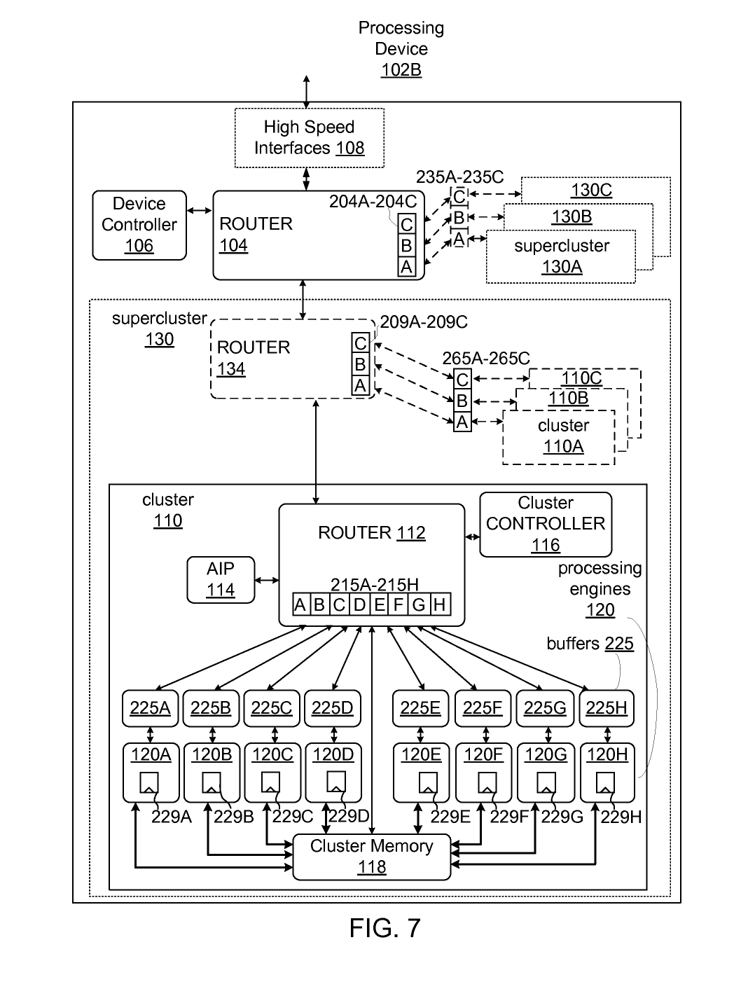

FIG. 6 is a flow diagram showing an exemplary process 200 of addressing a computing resource using a packet according to the present disclosure. An exemplary embodiment of the computing system 100 may have one or more processing devices configured to execute some or all of the operations of exemplary process 600 in response to instructions stored electronically on an electronic storage medium. The one or more processing devices may include one or more devices configured through hardware, firmware, and/or software to be specifically designed for execution of one or more of the operations of exemplary process 600.

The exemplary process 600 may start with block 602, at which a packet may be generated at a source computing resource of the exemplary embodiment of the computing system 100. The source computing resource may be, for example, a device controller 106, a cluster controller 118, a super cluster controller 132 if super cluster is implemented, an AIP 114, a memory controller for a cluster memory 118, or a processing engine 120. The generated packet may be an exemplary embodiment of the packet 140 according to the present disclosure. From block 602, the exemplary process 600 may continue to the block 604, where the packet may be transmitted to an appropriate router based on the source computing resource that generated the packet. For example, if the source computing resource is a device controller 106, the generated packet may be transmitted to a top level router 104 of the local processing device 102; if the source computing resource is a cluster controller 116, the generated packet may be transmitted to a router 112 of the local cluster 110; if the source computing resource is a memory controller of the cluster memory 118, the generated packet may be transmitted to a router 112 of the local cluster 110, or a router downstream of the router 112 if there are multiple cluster memories 118 coupled together by the router downstream of the router 112; and if the source computing resource is a processing engine 120, the generated packet may be transmitted to a router of the local cluster 110 if the destination is outside the local cluster and to a memory controller of the cluster memory 118 of the local cluster 110 if the destination is within the local cluster.

At block 606, a route for the generated packet may be determined at the router. As described herein, the generated packet may comprise a header that includes a single destination address. The single destination address may be any addressable location of a uniform memory space of the computing system 100. The uniform memory space may be an addressable space that covers all memories and registers for each device controller, cluster controller, super cluster controller if super cluster is implemented, cluster memory and processing engine of the computing system 100. In some embodiments, the addressable location may be part of a destination computing resource of the computing system 100. The destination computing resource may be, for example, another device controller 106, another cluster controller 118, a memory controller for another cluster memory 118, or another processing engine 120, which is different from the source computing resource. The router that received the generated packet may determine the route for the generated packet based on the single destination address. At block 608, the generated packet may be routed to its destination computing resource.

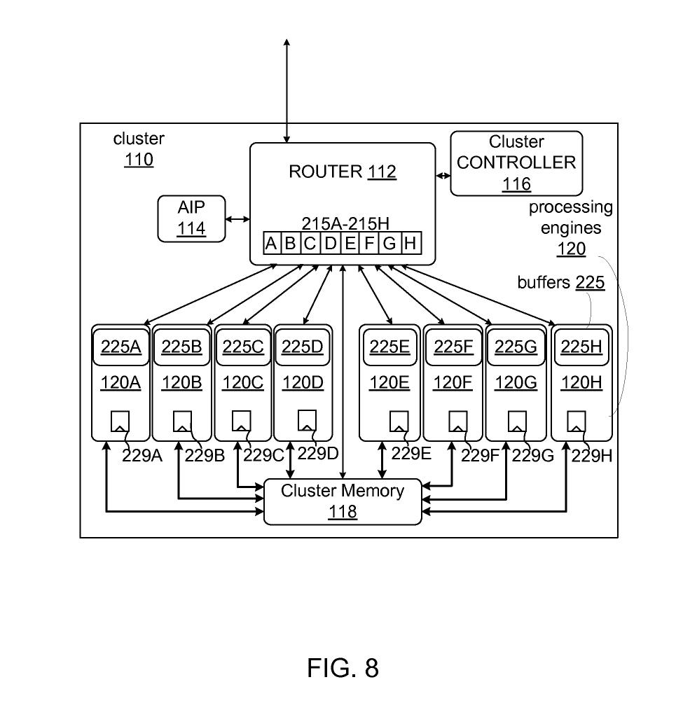

FIG. 7 illustrates an exemplary processing device 102B according to the present disclosure. The exemplary processing device 102B may be one particular embodiment of the processing device 102. Therefore, the processing device 102 referred to in the present disclosure may include any embodiments of the processing device 102, including the exemplary processing devices 102A and 120B. The exemplary processing device 102B may be used in any embodiments of the computing system 100. As shown in FIG. 7, the exemplary processing device 102B may comprise the device controller 106, router 104, one or more super clusters 130, one or more clusters 110, and a plurality of processing engines 120 as described herein. The super clusters 130 may be optional, and thus are shown in dashed lines.

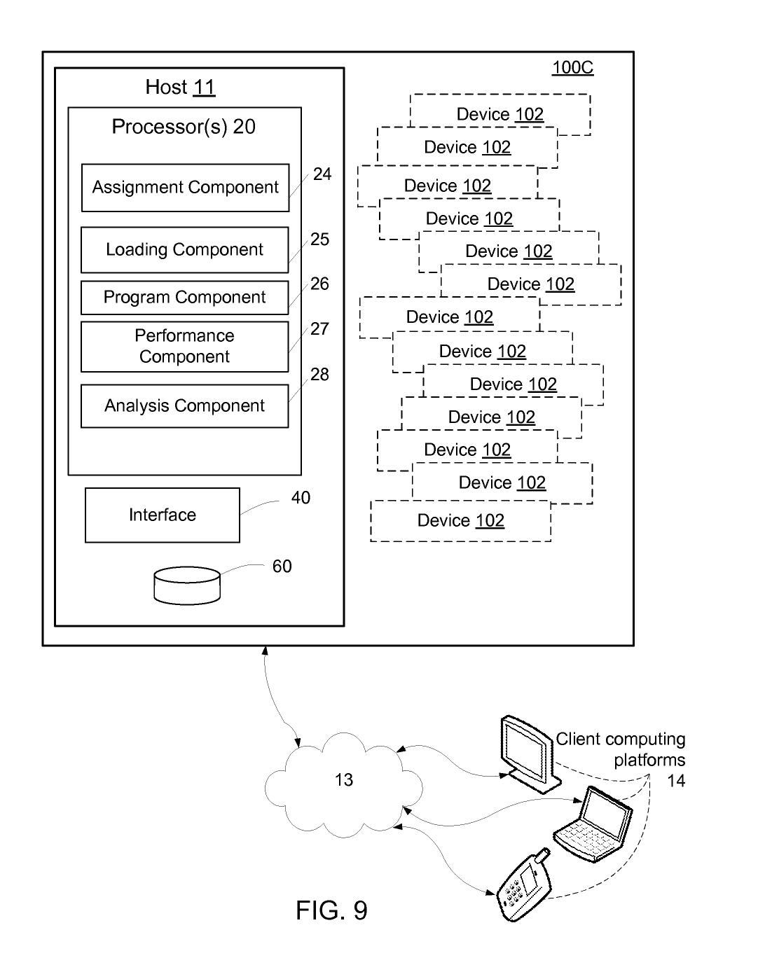

Certain components of the exemplary processing device 102B may comprise buffers. For example, the router 104 may comprise buffers 204A-204C, the router 134 may comprise buffers 209A-209C, the router 112 may comprise buffers 215A-215H. Each of the processing engines 120A-120H may have an associated buffer 225A-225H respectively. FIG. 8 shows an alternative embodiment of the processing engines 120A-120H such that the buffers 225A-225H may be incorporated into its associated processing engines 120A-102H. Combinations of the implementation of cluster 110 depicted in FIGS. 7 and 8 are considered within the scope of this disclosure. Also as shown in FIGS. 7 and 8, each processing engines 120A-120H may comprise a register 229A-229H respectively. In one embodiment, each of the registers 229A-229H may be a register. In another embodiment, each of the registers 229A-229H may be a register bit. Although one register 229 is shown in each processing engine, the register 229 may represent a plurality of registers for event signaling purposes. In some implementations, all or some of the same components may be implemented in multiple chips, and/or within a network of components that is not confined to a single chip. Connections between components as depicted in FIG. 7 and FIG. 8 may include examples of data and/or control connections within the exemplary processing device 102B, but are not intended to be limiting in any way. Further, as shown in FIGS. 7 and 8, each processing engines 120A-120H may comprise a buffer 225A-225H respectively, in one embodiment, each processing engines 120A-120H may comprise two or more buffers.

As used herein, buffers may be configured to accommodate communication between different components within a computing system. Alternatively, and/or simultaneously, buffers may include electronic storage, including but not limited to non-transient electronic storage. Examples of buffers may include, but are not limited to, queues, first-in-first-out buffers, stacks, first-in-last-out buffers, last-in-first-out buffers, registers, scratch memories, random-access memories, caches, on-chip communication fabric, switches, switch fabric, interconnect infrastructure, repeaters, and/or other structures suitable to accommodate communication within a multi-core computing system and/or support storage of information. An element within a computing system that serves a purpose as the point of origin for a transfer of information may be referred to as a source.

In some implementations, buffers may be configured to store information temporarily, in particular while the information is being transferred from a point of origin, via one or more buffers, to one or more destinations. Structures in the path from a source to a buffer, including the source, may be referred to as being upstream of the buffer. Structures in the path from a buffer to a destination, including the destination, may be referred to as being downstream of the buffer. The terms upstream and downstream may be used as directions and/or as adjectives. In some implementations, individual buffers, such as but not limited to buffers 225, may be configured to accommodate communication for a particular processing engine, between two particular processing engines, and/or among a set of processing engines. Individual ones of the one or more particular buffers may have a particular status, event, and/or activity associated therewith, jointly referred to as an event.

By way of non-limiting example, events may include a buffer becoming completely full, a buffer becoming completely empty, a buffer exceeding a threshold level of fullness or emptiness (this may be referred to as a watermark), a buffer experiencing an error condition, a buffer operating in a particular mode of operation, at least some of the functionality of a buffer being turned on or off, a particular type of information being stored in a buffer, particular information being stored in a buffer, a particular level of activity, or lack thereof, upstream and/or downstream of a buffer, and/or other events. In some implementations, a lack of activity may be conditioned on a duration of idleness meeting or exceeding a particular duration, e.g. a programmable duration.

In some implementations, idleness may be indicated by a buffer being empty, a lack of requests for information from downstream structures of a buffer, a lack of information coming in from upstream structures of a buffer, and/or other ways to indicate idleness of a particular buffer, as well as combinations of multiple ways that indicate a lack of activity. For example, a buffer associated with a processing engine may indicate a lack of activity regardless of whether the buffer is empty because the associated processing engine may execute program code that require some time to finish. In one embodiment, the status of a particular buffer may be set to idle responsive to both the following conditions being met: the buffer is completely empty and there has been a lack of requests for information from downstream structures for at least a predetermined duration. In another embodiment, the status of a particular buffer may be set to idle responsive to the following condition being met: no data been added to or removed from the queue for at least a predetermined duration. Other implementations of idleness are considered within the scope of this disclosure.

The particular state of a particular processing engine may further include instructions that effectuate generation of signals (e.g. setting a particular register) and/or information (e.g. generating a packet of information) that indicate a particular status, event, and/or activity of one or more particular buffers. For example, a given processing engine may execute a task according to a given state. The given state may include instructions to monitor the level of activity of two given buffers (the two buffers being used to accommodate communication by the given processing engine within a multi-core computing system). For a particular implementation of idleness, a counter may count how many clock cycles both given buffers are considered idle (and/or considered to have a status corresponding to idleness as used in a particular implementation). If either of the two given buffers becomes active (e.g. information is written into the buffer), the counter may reset to zero. Once the counter reaches a predetermined number of clock cycles, both given buffers are deemed to lack activity. The predetermined number of clock cycles may correspond to a particular duration of time. Responsive to the counter reaching the predetermined number, a particular event may be generated (e.g., a particular register may be set to a value that indicates that the related buffers lack activity, at least for the particular duration of time). The particular event may be used elsewhere within the multi-core computing system, e.g. to initiate the process of assigning a new task to the given processing engine. In one embodiment, instead of setting a particular register, a single register bit may be set to indicate occurrence of an event.

In some implementations, a set of conditions may be combined in a logical combination to generate a signal (e.g. setting a particular register or a register bit) and/or information (e.g. generating a packet of information) that indicate a particular status. One or more of the conditions of such a set of conditions may be unrelated to idleness. For example, a condition may be that a particular point in a program and/or a particular task in an application has been reached, initiated, and/or completed. In addition to a logical combination, in some implementations, a set of conditions may be a temporal or sequential combination. For example, a first particular event may need to occur prior to the occurrence of a second particular event, and/or both particular events may need to occur subsequent to the occurrence of a third particular event, and so forth. Combinations of logical and sequential events and/or conditions are envisioned within the scope of this disclosure.

In embodiments according to the present disclosure, multiple processing engines may be configured to run related processes and/or unrelated processes. For example, a first processing engine may perform a mathematical function on a first set of data, while a second processing engine may perform a process such as monitoring a stream of data items for a particular value. In some implementations, the processes of both processing engines in this example may be unrelated and/or independent. Alternatively, these processes may be related in one or more ways. For example, the mathematical function may only be performed after the particular value has been found in the process running on the second processing engine. Alternatively, the mathematical function may cease to be performed after the particular value has been found. Alternatively, and/or simultaneously, the mathematical function and the process running on the second processing engine may be started and/or stopped together, for example under control of a process running on a third processing engine. For example, the mathematical function running on the first processing engine, the process running on the second processing engine, and/or other processes may be part of an interconnected set of tasks that form an application.

Processes to be executed by one or more processing engines may be nested hierarchically and/or sequentially. For example, a first processing engine may perform a first mathematical function on a first set of data, while a second processing engine may perform a different function on a second set of data that includes—as at least one of its input—one or more results of the first mathematical function (e.g. in some implementations, a set or stream of values may be the result of the first mathematical function). In the latter example, the processes of both processing engines are related and/or dependent, e.g. hierarchically and/or sequentially.

By way of illustration, assume for a particular scenario or case that the computing system 100 may assign a sequence of tasks (for example, an application) to the processing engines 120A and 120B. Processing engines 120A and 120B may need to be synchronized at some point in order for the next task in the sequence of tasks to continue on a processing engine, which could be any of the processing engines 120A-120B, one of the processing engines 120C-120H, a processing engine 120 in a different cluster 110 or a processing engine 120 in a different processing device 102. In an embodiment, data (program code and/or pieces of information upon which the program code operates) needed to execute the sequence of tasks on either processing engines 120A or 120B may come from outside of the cluster 110. For example, the tasks may be assigned by a host of the computing system 100 and the exemplary processing device 102B may be part of the computing system 100. The host may load the tasks, assign the tasks to the processing engines 120A and 120B of the processing devices 102B, and send the data for the assigned tasks to the processing engines 120A and 120B respectively. The data to be transmitted may be buffered at the router 104 (e.g., using one or more buffers 240A-240C), at the router 134 (e.g., using one or more buffers 209A-209C) (if super clusters are implemented), at the router 112 (e.g., using one or more buffers 215A-215H) and/or at the destination processing engine 120A and/or 120B.

During execution of the first task, for example, by the processing engine 120A, the buffer 225A may be in frequent use, e.g. to transfer data to the processing engine 120A, to transfer results, output, and/or other data from the processing engine 120A to other parts of the computing system 100, and/or to accommodate other types of communication during the first task. Once processing engine 120A has completed the task, the activity level of buffer 225A may drop, e.g. to a level that indicates idleness. In one embodiment, individual register may be used to indicate idleness for individual buffers. A particular register of the processing engine 120A, for example, the register 229A may be configured to reflect this idleness. Implementations using other mechanisms to reflect this idleness, e.g. though a signal, interrupt, exception, packet, and/or other mechanism, are also within the scope of the present disclosure. It should be noted that although the register 229A is shown to be within the processing 120A, it may also be within the buffer 225A, and/or elsewhere within the computing system 100, depending on the particular implementation of the computing system 100.

The task or process running on the processing engine 120B may, at some point, be notified and/or discover that the buffer 225A is considered idle (and/or considered to have a status corresponding to idleness as used in a particular implementation). In other words, in some implementations, this information may be pushed and/or pulled. Such notification may for example be implemented as an event flag, which may be set in another part of the processing engine 120, such as but not limited to another register or register bit, and may be pushed and/or pulled from the processing engine 120 (by the device controller 106 and/or by the host of the computing system 100). Other implementations that allow an event related to the processing engine 220A to become apparent, known, or noticed by the processing engine 220B are also within the scope of this disclosure. Once the processing engine 120B has gained the knowledge that the processing engine 120A appears to be idle (and/or considered to have a status corresponding to idleness as used in a particular implementation), the processing engine 120B may take appropriate actions, such as but not limited to, resume a task that the processing engine 120B may have stopped, send data to the processing engine 120A, coordinate with the processing engine 120A to work on the next task in the sequence of tasks.

Although for ease of explanation the above example describes assigning two tasks to processing engines 120A and 120B, it is to be understood that embodiments according to the present disclosure may assign hundreds, thousands, hundreds of thousands (or any number for that matter) of tasks to hundreds, thousands, hundreds of thousands (or any number for that matter) of processing engines at processing engine level, cluster level, super cluster level (if super clusters are implemented) and/or processing engine level.

In a variation on the preceding scenario or case, additional buffers may be included in a path from the router 104 to the processing engines 120, in addition to the buffers 204, 209, 215 and 225. For example, buffers 265A, 265B, and 265C may be positioned between the router 134 and clusters 110A, 110B, and 110C, respectively; and buffers 235A, 235B, and 235C may be positioned between the router 104 and super clusters 130A, 130B, and 130C, respectively. The buffers shown at the various levels within the hierarchy of system 100 are merely illustrative, and not intended to be limiting in any way. For example, in one embodiment that has no super cluster 130, there may be additional buffers between the buffer 204 of the router 104 and buffer 215 of the router 112.

In one embodiment, a particular register (e.g. register 229A) may be configured to reflect the combined idleness of buffer 225A and a corresponding buffer 215 (e.g., buffer 215A). The particular register may be configured to only indicate simultaneous idleness of both buffers when both buffers 225A and 215A are considered idle at the same time (and/or considered to both have a status corresponding to idleness as used in a particular implementation), and therefore the implied idleness of processing engine 120A. In such implementations, the processing engine 120B that has been assigned tasks in the same sequence of tasks as the processing engine 120A, the device controller 106 and/or the host of the computing system 100 may be configured to monitor all the pertinent register bits for the particular logical combination that indicates all pertinent buffers are idle, and therefore determine that the processing engine 120A is idle. Once processing engine 120B notices that processing engine 120A appears to be idle, processing engine 220B may take appropriate actions, such as but not limited to, resume a task that the processing engine 120B may have stopped, send data to the processing engine 120A, coordinate with the processing engine 120A to work on the next task in the sequence of tasks, etc.

Referring to FIG. 7, synchronization among processing engines 120 may be based on, among other features, an ability of individual ones of processing engines 120 to determine whether one or more individual buffers (e.g. buffers 225) and/or other components of processing device 102B may be idle (and/or considered to have a status corresponding to idleness as used in a particular implementation). Individual ones of processing engines 120 may be configured to execute tasks according to a particular current state. The current state may include instructions to be executed. Synchronization between processing engines 120 need not be limited to a single cluster or super cluster, but may extend anywhere within the processing device 102B and/or between multiple processing devices 102B. For example, if any of the scenarios described herein where a second processing engine 120 is configured to take appropriate actions upon detection (or being notified) of the processing engine 120A being idle, the second processing engine 120 may be part of a different cluster 110, super cluster 130, or processing device 102B than processing engine 120A.

Synchronization between processing engines 120 may be based on, among other features, an ability of processing engines 120 to reversibly suspend their own execution, which may be referred to as “going to sleep.” Synchronization between processing engines 120 need not be limited to a single cluster or super cluster, but may extend anywhere within a processing device 102 and/or between multiple processing devices 102 in a computing system 100.

In some implementations, a particular processing engine 120 may be configured to execute one or more instructions (from a set of instructions) that reversibly suspend execution of instructions by that particular processing engine 120. Other components within a computing system 100, including but not limited to components at different levels within a hierarchy of a processing device 102, may be configured to cause such a suspension to be reversed, which may be referred to as “waking up” a (suspended) processing engine.

Processing engines 120 may be configured to operate in one or more modes of power consumption, including a low-power mode of consumption (e.g. when the processing engine has gone to sleep) and one or more regular power modes of consumption when execution is not suspended. In some implementations, the low power mode of consumption reduces power usage by a factor of at least ten compared to power usage when execution is not suspended. In some implementations, waking up a processing engine may be implemented as exiting the low-power mode of power consumption.

In one embodiment, individual processing engines 120 may generate and send signals to indicate one or more occurrences of one or more events within the individual processing engine 120. As used herein, signals indicative of events may be referred to as event signals and the term “event” may also mean the signal representing an occurrence of the event. An event may interchangeably refer to any event, status, activity (or inactivity) of a processing element of the computing system according to the present disclosure. For example, an event may be related to and/or associated with an access of a memory or a buffer within individual processing engine 120, including but not limited to a read access of a memory, a write access of a memory, a busy signal for a memory arbiter or buffer arbiter, a FIFO-full indication of a first-in-first-out (FIFO) buffer, etc. Alternatively, and/or simultaneously, an event may be related to and/or associated with a delay of processing within an individual processing engine 120. For example, an event may indicate congestion in data transfer, a status of non-responsiveness, a status that indicates waiting for instructions, data and/or other information, and/or other types of processing delays and/or bottlenecks. Alternatively, and/or simultaneously, an event may be related to and/or associated with a (completion of an) execution of an instruction and/or task within individual processing engine 120.

In some embodiments, whether an event has occurred in a computing resource may be based on an amount of time during which certain activity or activities have or have not occurred. In one embodiment, one or more timing registers may be implemented. For example, such timing registers may be implemented by a processing engine 120, a cluster 110, a super cluster 130, and/or a processing device 102. One timing register may be used, for example, to record the time since the last activity in one of the buffers, and another timing register may be used to record time since the last activity in another of the buffers. As used herein, a timing register may also be referred to as a timer. The timing register may be implemented at one or more of processing engine level, cluster level, super cluster level and processing device level. In one embodiment, one or more timing registers may be implemented on each of the levels of the hierarchy on a processing device 102. In another embodiment, one or more timing registers may be implemented on a processing device 102 at the processing device level but may be programmed or configured to be used for each processing engines 120, clusters 110 and/or super clusters 130 individually.

Event signals generated at the processing engine level may be propagated from the processing engine 120 to cluster level, super cluster level, processing device level and/or a host of the computing system 100. Event signal propagation may be implemented, in a non-limiting example, by multiplexers at cluster level, at super cluster level and/or processing device level. For example, a host of a computing system 100 may receive event signals from all processing devices 102 within the computing system 100; a processing device 102 may receive event signals propagated from all super clusters 130 (if super clusters are implemented), cluster 110, and/or processing engines 120 within the processing device 102; a super cluster 130 may receive event signals propagated from all clusters 110 and/or processing engines 120 within the super cluster 130; and a cluster 110 may receive event signals propagated from all processing engines 120.

In one embodiment, in addition to propagating event signals, each of the clusters 110, super clusters 130 and processing devices 102 may generate event signals by itself. For example, a cluster 110 may generate an event signal based on activity levels of a specified subset or all of processing engines 120 within the cluster 110 to indicate an activity level for the cluster as a whole; a super cluster 130 may generate an event signal based on activity levels of a specified subset or all of processing engines 120 within the super cluster 130 to indicate an activity level for the super cluster 130 as a whole; and a processing device 102 may generate an event signal based on activity levels of a specified subset or all of processing engines 120 within the processing device 102 to indicate an activity level for the processing device as a whole. For example, if of all processing engines 120A-120H, only the processing engines 120A and 120B may have been assigned tasks to execute, a cluster level event may be generated based on activity levels on the processing engines 120A and 120B (e.g., activity levels of buffers 225A and 225B) instead of all processing engines 120A-120H in the cluster 110.

The event signals may be stored in event registers at the cluster 110, super cluster 130 and/or processing devices 102 level, and may be collected by a host in the computer system 100. It should be noted that, in one embodiment, there may be separate event signals for computation activity (e.g., based on event registers 229 of the processing engines 120), network activity (e.g., based on event registers (not shown) of the routers 104, 112, and 134) and/or memory access activity (e.g., based on event registers of the cluster memories 118). In one embodiment, the event signals may comprise one or more bits and each event signal may be in a “set” or “non-set” value. A “set” value may indicate the event represented by the event signal has occurred and a “non-set” value may indicate that the event represented by the event signal has not occurred. Therefore, the event signal may also be used to represent states of a respective processing element, such as but not limited to, whether a buffer is empty, and whether a buffer has been idle for a certain amount of time.

As described herein, event signals may be generated based on timing. For example, one or more processing engines 120A-120H may be assigned some tasks, and the cluster 110 may generate an event signal indicating that the cluster 110 is idle only when all buffers 225A-225H have been idle for a time threshold. The time threshold may be a predetermined amount of time and stored in a programmable register that may be updated from time to time or at appropriate time. The predetermined amount of time may be different or the same for processing engine, cluster, super cluster and processing device levels. For example, a time threshold for determining whether a processing engine 120 is idle may be different from a time threshold for determining whether a cluster, a super cluster, or a processing device is idle. Moreover, the predetermined amount of time may also be different or the same for different components. For example, there may be one time threshold for determining whether a processing engine is idle, another time threshold for determining whether a router 102 is idle, and/or a different time threshold for determining whether a router 112 is idle.

In one embodiment, the predetermined amount of time may be set by, for example, a programmer, a system administrator, or a software program that may dynamically adjust parameters for the operation of the computing system 100. The programmable register for timing may be implemented by one or more registers at the processing device level, the super cluster level, the cluster level and/or processing engine level. In one embodiment, the programmable register for timing may be re-used for different purposes and contain different values for the different purposes. For example, during a certain time period, a programmable register at a processing device 102 may be used for activities within a cluster 110 and during a different timer period, the same programmable register may be used for latency of the buffer 204.

The timers used for counting the time may be implemented in incrementing and/or decrementing manners. In one embodiment, a timer may be started based on one or more event signals. If there is no change to any of the one or more event signals until the counted time reaches the respective time threshold, another event signal may be generated. If, however, anyone of the one or more event signals changes its event signal, the timer may be reset. For example, a timer for the cluster 110 may be started based on the event signals from the processing engines 120A-120H that they are idle and the timer may start when the latest idle event signal is received. If anyone of processing engines 120A-120H changes its state from idle (e.g., from “set” to “non-set”), the timer for the cluster 110 may be reset. If the processing engines 120A-120H maintain their idle states until the timer reaches a predetermined amount of time, an event signal may be generated indicating the cluster 110 is itself idle. In this example, the processing engines 120A-120H may be reduced to a specified subset, for example, only processing engines 120A and 120B, if only processing engines 120A and 120B may be relevant to determine whether the cluster 110 is idle. Further, in this example, the cluster 110 may be replaced with the super cluster 130 or the processing device 102, and correspondingly the processing engines 120A-120H may be replaced by a specified subset or all of the processing engines within the super cluster 130 or a specified subset or all of the processing engines within the processing device 102.

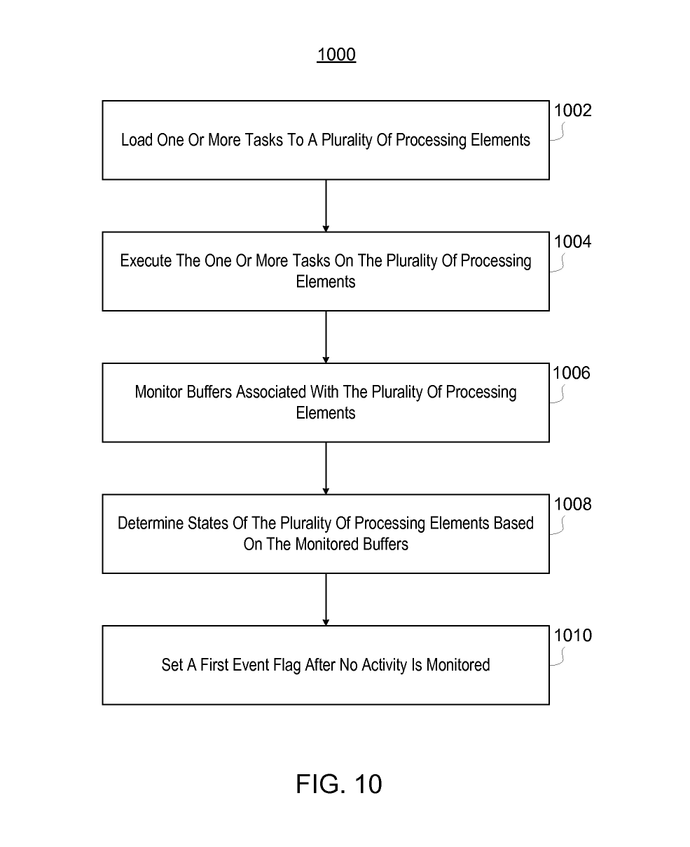

Event, status, activity and any other information related to the operating state of a computing system comprising a plurality of processing devices 102 may be generated, counted and/or collected at each of the processing engine, cluster, super cluster, and/or processing device level. The computing system may comprise a host that collects all that information from all computing resources across the computing system. FIG. 9 illustrates an exemplary host 11 configured to synchronize tasks among processing elements in an exemplary computing system 100C according to the present disclosure. The exemplary computing system 100C may be an example of the computing system 100 and may implement all features of the computing system 100 described herein. The host 11 may be an example of a host for the computing system 100 and may implement all features of a host of the computing system 100 described herein. As depicted in FIG. 9, the computing system 100C may comprise a plurality of processing devices 102 in addition to the host 11. The number of processing devices 102 may be as low as a couple or as high as hundreds of thousands, or even higher limited only by the width of DEVID. The exact number of processing devices 102 is immaterial and thus, the processing devices 102 are shown in phantom. Moreover, in one embodiment, each of the processing devices 102 may be an embodiment of the processing device 102B as shown in FIG. 7. The processing engines 120 on each processing device 102 may implement buffers 225 (as shown in FIG. 7 or FIG. 8). The host 11 may comprise one or more processors 20, a physical storage 60, and an interface 40. The processing elements that may be assigned tasks may include processing engines 120 and/or processing devices 102. If a task is assigned to a processing device 102, the processing device 102 may implement functionality to further assign the task to one of the processing engines 120 of the processing device 102. In one embodiment, the topology and/or interconnections within the computing system 100C may be fixed. In another embodiment, the topology and/or interconnections within the computing system 100C may be programmable.

Interface 40 may be configured to provide an interface between the computing system 100C and a user (e.g., a system administrator) through which the user can provide and/or receive information. This enables data, results, and/or instructions and any other communicable items, collectively referred to as “information,” to be communicated between the user and the computing system 100C. Examples of interface devices suitable for inclusion in interface 40 include a keypad, buttons, switches, a keyboard, knobs, levers, a display screen, a touch screen, speakers, a microphone, an indicator light, an audible alarm, and a printer. Information may be provided by interface 40 in the form of auditory signals, visual signals, tactile signals, and/or other sensory signals.

It is to be understood that other communication techniques, either hard-wired or wireless, are also contemplated herein as interface 40. For example, in some implementations, interface 40 may be integrated with physical storage 60. In this example, information is loaded into computing system 100C from storage (e.g., a smart card, a flash drive, a removable disk, etc.) that enables the user(s) to customize the implementation of computing system 100C. Other exemplary input devices and techniques adapted for use with computing system 100C as interface 40 include, but are not limited to, an RS-232 port, RF link, an IR link, modem (telephone, cable, Ethernet, internet or other). In short, any technique for communicating information with computing system 100C is contemplated as interface 40.

One or more processors 20 (interchangeably referred to herein as processor 20) may be configured to execute computer program components. The computer program components may include an assignment component 24, a loading component 25, a program component 26, a performance component 27, an analysis component 28, and/or other components. The functionality provided by components 24-28 may be attributed for illustrative purposes to one or more particular components of system 100C. This is not intended to be limiting in any way, and any functionality may be provided by any component or entity described herein.

The functionality provided by components 24-28 may be used to load and execute one or more computer applications, including but not limited to one or more computer test applications, one or more computer web server applications, or one or more computer database management applications. An application may comprise one or more tasks, e.g. a set of interconnected tasks that jointly form the application. The applications may include test applications used to determine, measure, estimate, debug, and/or monitor the functionality and/or performance of a particular processing engine, cluster, super cluster and/or a multi-core processing system. As used herein, references to a system's functionality and/or performance are considered to include a system's design, testing, calibration, configuration, load balancing, and/or operation at any phase during its lifecycle. System 100C may be configured to divide applications, including but not limited to test application, into sets of interconnected tasks. For example, an application could include software-defined radio (SDR) or some representative portion thereof. For example, a test application could be based on an application such as SDR, for example by scaling down the scope to make testing easier and/or faster. By way of non-limiting example, a SDR application may include one or more of a mixer, a filter, an amplifier, a modulator, a demodulator, a detector, and/or other tasks and/or components that, when interconnected, may form an application. In another example, a software application may comprise a plurality of modules that may be treated as separate tasks, such as but not limited to, dynamic link libraries (DLLs), Java Archive (JAR) packages, and similar libraries on UNIX®, ANDROID® or MAC® operating systems.

Loading component 25 may be configured to load, link, and/or program instructions, state, functions, and/or connections into computing system 100C and/or its components. State may include data, including but not limited to, program code and information upon which the program code may operate for operating the system 100C (e.g., an operating system) and/or software applications to be executed by the system 100C. State may also include information regarding interconnections among the host 11 and the processing devices 102, clusters 110, super clusters 130 (if super clusters are implemented), and/or set of processing engines 120, and/or other information needed to execute a particular task (or any other part of a software application). The program code may include instructions that generate signals (and/or effectuate generation of signals) that are indicative of occurrences of particular events, status, and/or activity within processing devices 102 and/or various buffers within the processing devices 102. In some implementations, the state may be determined by program component 26. In some implementations, loading component 25 may be configured to load and/or program a set of processing engines 120 and/or buffers (e.g. the same as or similar to processing engines 120 and/or any buffers shown in FIG. 7 or 8), a set of interconnections, and/or additional functionality into system 100C. For example, additional functionality may include input processing, memory storage, data transfer within one or more processing engines 120, output processing, and/or other functionality. By virtue of the synchronization mechanisms described in this disclosure, a multi-core processing system such as the computing system 100C including multiple processing devices 102 and/or processing engines 120 may be more easily configured, partitioned, and/or load-balanced while maintaining functionally correct interoperation between multiple processing engines 120. In some implementations, loading component 25 may be configured to execute (at least part of) applications, e.g. responsive to functions and/or connections being loaded into system 100C and/or its components.

Assignment component 24 may be configured to assign one or more computing resources within the computing system 100C to perform one or more tasks. The computing resources that may be assigned tasks may include processing devices 102, clusters 110, super clusters 130 (if super clusters are implemented), and/or processing engines 120. In some implementations, assignment component 24 may be configured to perform assignments in accordance with and/or based on a particular routing. For example, a routing may limit the number of processing devices 102 and/or processing engines 120 that are directly connected to a particular processing engine 120. In some implementations, by way of non-limiting example, the routing of a network of processing devices 102 may be fixed (i.e. the hardware connections between different processing devices 102 may be fixed), but the assignment of particular tasks to specific computing resources may be refined, improved, and/or optimized in pursuit of higher performance. In some implementations, by way of non-limiting example, the routing of a network of processing engines 102 may not be fixed (i.e. programmable between iterations of performing an assignment and determining the performance of a particular assignment), and the assignment of particular tasks to specific processing devices 102 and/or processing engines 120 may be also be adjusted, e.g. in pursuit of higher performance.

Assignment component 24 may be configured to determine and/or perform assignments of tasks repeatedly, e.g. in the pursuit of higher performance. Assignments of tasks may be performed conditional to one or more particular processing engines 120 or processing devices 102 being idle (and/or being considered to have a status corresponding to idleness as used in a particular implementation). As used herein, any association (or correspondence) involving applications, chips, processing engines, tasks, and/or other entities related to the operation of systems described herein, may be a one-to-one association, a one-to-many association, a many-to-one association, and/or a many-to-many association or N-to-M association (note that N and M may be different numbers greater than 1). For example, assignment component 24 may assign one or more processing engines 120 distributed among one or more processing devices 102 to perform the task or tasks of one or more mixers of an SDR application. Assignment of tasks to a combination including one or more processing engines 120 and one or more processing devices 102 may also be envisioned within the scope of this disclosure.

Program component 26 may be configured to determine state for processing devices 102, clusters 110, super clusters 130 (if super clusters are implemented), and/or processing engines 120. The particular state for a particular cluster 110, super cluster 130 (if super clusters are implemented), or processing engine 120 may be in accordance with an assignment and/or routing from another component of system 100C. In some implementations, program component 26 may be configured to program and/or load instructions and/or state into one or more clusters 110, super clusters 130 (if super clusters are implemented), and/or processing engines 120. In some implementations, programming individual processing engines 120, clusters 110, super clusters 130 (if super clusters are implemented), and/or processing devices 102 may include setting and/or writing control registers, for example, CCRs for cluster controllers 116 and super cluster controllers 132, control registers within the device controller 106, or control registers within the processing engines 120.

By way of illustration, the host 11 may assign a sequence of tasks, e.g. an application formed by interrelated tasks to the processing engine 120A and processing engine 120B of one processing device 102 as shown in FIG. 7. The processing engine 120A and 120B may need to be synchronized at a certain point. For example, assume that a first task in the sequence of tasks is assigned to the processing engine 120A and a second task in the sequence of tasks is assigned to the processing engine 120B. While processing engines 120A and 120B are busy executing their respective assigned task, they may not be assigned another task. As described herein, the processing engines 120A and 120B may comprise buffers 225A and 225B respectively for receiving data from and send data to other parts of the device 102 (including other parts of the computing system 110C via the router 104).

During execution of the first task by processing engine 120A, buffer 225A may be in frequent use, e.g. to receive data sent to processing engine 120A, to transfer results, output and/or other data from processing engine 120A to other parts of the processing device 102 (including other part of the computing system 100C via the router 104), and/or to accommodate other types of communication during the first task. During execution of the second task by processing engine 120B, buffer 225B may be in frequent use, e.g. to receive data sent to processing engine 120B, to transfer results, output, and/or other data from processing engine 120B to other parts of the processing device 102 (including other part of the computing system 100C via the router 104), and/or to accommodate other types of communication during the second task. Once either processing engines 120A or 120B has completed its respective task, the activity level of buffer 225A or 225B may drop, e.g. to a level that indicates idleness. The register bits 229A and 229B may be configured to reflect this idleness respectively. Although FIGS. 7 and 8 show the registers 229 are located within respective processing engines 120A-120H, in another embodiment, the registers 229 may reside within the buffer 225 and/or elsewhere within system 100C, depending on the particular implementation of system 100. Implementations using other mechanisms to reflect idleness, e.g. though a signal, interrupt, exception, packet, and/or other mechanism, are also within the scope of this disclosure.

The host 11 may, at some point, be notified and/or discover that buffer 225A and buffer 225B are considered idle (and/or considered to have a status corresponding to idleness as used in a particular implementation). In other words, in some implementations, this information may be pushed and/or pulled. Such notification may for example be implemented as an event flag, which may be another part of the processing engine 120 and may be pushed and/or pulled from the processing engine 120 (by the device controller 106 and/or by the host of the computing system 100). Other implementations that allow an event related to processing engine 120A or processing engine 120B to become apparent, known, or noticed by host 11 are also within the scope of this disclosure.

In one embodiment, once host 11 has gained the knowledge that processing engine 120A and/or processing engine 120B appear to be idle (and/or considered to have a status corresponding to idleness as used in a particular implementation), host 11 may assign the next one or more tasks in the sequence of tasks to processing engine 120A or processing engine 120B for execution, as appropriate in the context of the sequence of tasks, which may be interrelated. Moreover, in one embodiment, the host 11 may also activate a processing engine that may have been idle because it is waiting for certain activity (or activities) to occur first. For example, the processing engine 120B may need to wait for the processing engine 120A to finish certain computation task (or portion thereof) before it can start (or resume) processing a task assigned to itself. It should be noted that such a notification may be implemented such that involvement of host 11 may not be necessary. For example, the cluster 110, the super cluster 130 and/or the processing device 102 may implement a notification to be sent to the related processing engine (in this case processing engine 120B) when an event of idleness of the processing engine 110A has occurred

In some implementations, host 11 may assign the next task to either processing engine 120A or 120B depending on which processing engine has completed their respective previous task first. In some implementations, host 11 may assign the next one or more tasks to both processing engine 120A and 120B once both the first task and the second tasks have been completed. In another embodiment, host 11 may designate at least part of its functionality to another processing engine 120 such that this designated processing engine 120 may perform certain functions, such as but not limited to, monitoring the status of the processing engines 120A and 120B, assign new tasks from the sequence of tasks to the processing engines 120A and/or 120B once either or both of them finish their respective tasks. Different logical combinations and sequential combinations of tasks are envisioned within the scope of this disclosure.

Performance component 27 may be configured to determine performance parameters of computing system 100C, one or more processing devices 102, one or more clusters 110, one or more super clusters 130 (if super cluster is implemented), one or more processing engines 120, and/or other configurations or combinations of processing elements described herein. In some implementations, one or more performance parameters may indicate the performance and/or functionality of an assignment of tasks (and/or a sequence of assignments of tasks), as performed by the computing system 100C. For example, one or more performance parameters may indicate bottlenecks, speed, delays, and/or other characteristics of performance and/or functionality for computing resources within the system 100C, such as but not limited to memories, routers, processing engines. In some implementations, performance may be associated with a particular application, e.g. a test application, or a particular strategy used to assign tasks to processors. In some implementations, one or more performance parameters may be based on signals generated within and/or by one or more processing engines 120 or other components of one or more processing devices 102 (including the various buffers shown in FIG. 7) and/or other components of system 100C. For example, the generated signals may be indicative of occurrences or events within a particular component of system 100C, as described elsewhere herein. By virtue of the synchronization mechanisms described in this disclosure, the performance of (different configurations and/or different assignments of) multi-core processing systems may be monitored, determined, and/or compared.

Analysis component 28 may be configured to analyze performance parameters. In some implementations, analysis component 28 may be configured to compare performance of different configurations of multi-core processing systems, different ways to divide an application into a set of interconnected tasks by a programmer (or a compiler, or an assembler), different assignments by assignment component 24, and/or other different options used during the configuration, design, and/or operation of a multi-core processing system.

In some implementations, analysis component 28 may be configured to indicate a bottleneck and/or other performance issue in terms of memory access, computational load, and/or communication between multiple processing elements/engines. For example, one task may be loaded on a processing engine and executed on it. If the processing engine is kept busy (e.g., no event signal of idleness) for a predetermined amount of time, then the task may be identified as a computation intensive task and a good candidate to be executed in parallel, such as being executed in two or more processing engines. In another example, two processing engines may be assigned to execute some program code respectively (could be one task split between the two processing engines, or each processing engine executing one of two interconnected tasks). If each of the two processing engines spends more than a predetermined percentage of time (e.g., 10%, 20%, 30% or another percentage, which may be programmable) waiting on other processing engine (e.g., for data or an event signal), then the program code may be identified as communication intensive task(s) and a good candidate to be executed on a single processing engine, or moved to be closer (such as but not limited to, two processing engines in one cluster, two processing engines in one super cluster, or two processing engines in one processing device).

Referring to FIG. 9, one or more processors 20 may be configured to provide information-processing capabilities in computing system 100C and/or host 11. As such, processor 20 may include one or more of a digital processor, an analog processor, a digital circuit designed to process information, an analog circuit designed to process information, a state machine, and/or other mechanisms for electronically processing information. Although processor 20 may be shown in FIG. 9 as a single entity, this is for illustrative purposes only. In one embodiment, processor 20 may include a plurality of processing units. For example, each processor 20 may be a processing device 102 or a processor of a different type as described herein. These processing units may be physically located within the same physical apparatus, or processor 20 may represent processing functionality of a plurality of apparatuses operating in coordination (e.g., “in the cloud”, and/or other virtualized processing solutions).

It should be appreciated that although components 24-28 are illustrated in FIG. 9 as being co-located within a single processing unit, in implementations in which processor 20 includes multiple processing units, one or more of components 24-28 may be located remotely from the other components. The description of the functionality provided by the different components 24-28 described herein is for illustrative purposes, and is not intended to be limiting, as any of components 24-28 may provide more or less functionality than is described. For example, one or more of components 24-28 may be eliminated, and some or all of its functionality may be provided by other ones of components 24-28. As another example, processor 20 may be configured to execute one or more additional components that may perform some or all of the functionality attributed herein to one of components 24-28.

Physical storage 60 of computing system 100C in FIG. 9 may comprise electronic storage media that stores information. In some implementations, physical storage 60 may store representations of computer program components, including instructions that implement the computer program components. The electronic storage media of physical storage 60 may include one or both of system storage that is provided integrally (i.e., substantially non-removable) with host 11 and/or removable storage that is removably connectable to host 11 via, for example, a port (e.g., a USB port, a FIREWIRE port, etc.) or a drive (e.g., a disk drive, etc.). Physical storage 60 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), network-attached storage (NAS), and/or other electronically readable storage media. Physical storage 60 may include virtual storage resources, such as storage resources provided via a cloud and/or a virtual private network. Physical storage 60 may store software algorithms, information determined by processor 20, information received via client computing platforms 14, and/or other information that enable host 11 and computing system 100C to function properly. Physical storage 60 may be one or more separate components within system 100C, or physical storage 60 may be provided integrally with one or more other components of computing system 100C (e.g., processor 20).

Users may interact with system 100C through client computing platforms 14. By way of non-limiting example, client computing platforms may include one or more of a desktop computer, a laptop computer, a handheld computer, a NetBook, a Smartphone, a tablet, a mobile computing platform, a gaming console, a television, a device for streaming internet media, and/or other computing platforms. Interaction between the system 100C and client computing platforms may be supported by one or more networks 13, including but not limited to the Internet.

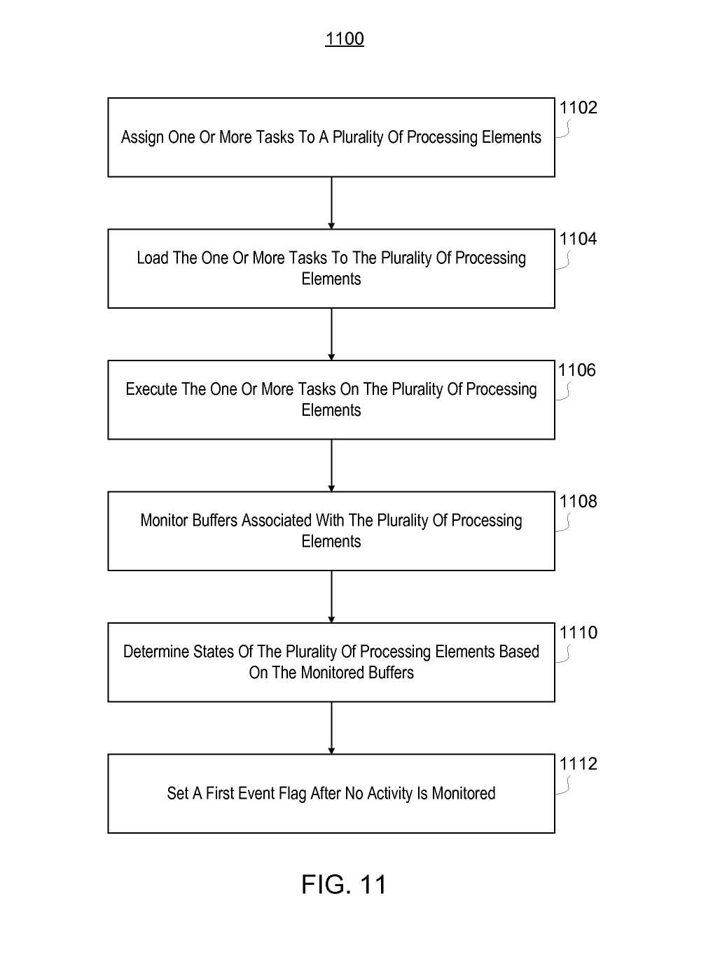

FIGS. 10 and 11 illustrate exemplary processes 1000 and 1100 of synchronizing processing elements within a processing device and within a multi-core computing system, respectively, according to the present disclosure. Each of the processing elements may be a processing engine 120, a cluster 110, a super cluster 130 (if super clusters are implemented) or a processing device 102. The operations of processes 1000 and 1100 presented below are intended to be illustrative. In some implementations, processes 1000 and 1100 may be accomplished with one or more additional operations not described, and/or without one or more of the operations discussed. Additionally, the order in which the operations of processes 1000 and 1100 are illustrated in FIGS. 10 and 11 and described below is not intended to be limiting.

One example of processing device configured to execute the exemplary process 1000 may be an exemplary embodiment of the processing device 102 (including 102A or 102B), in which the various components of the processing device 102, such as but not limited to, one or more of the processing engines 120, clusters 110, and super clusters 130 and the processing device 102 itself, may be configured through hardware, firmware, and/or software to be specifically designed for execution of one or more of the operations of exemplary process 1000.

The exemplary process 1000 may start with block 1002, at which one or more tasks may be loaded to two or more processing elements of a plurality of processing elements. For example, a processing device 102 may comprise a plurality of processing elements, such as 256 processing engines in one embodiment of the processing device 102. As described herein, in some embodiments, the processing engines may be grouped into clusters and in one of such embodiments, the clusters may be further grouped into super clusters. Tasks may be assigned, for example, to processing engines, to clusters, to super clusters (if super clusters are implemented), and/or to processing engines. Not all processing elements may be needed to execute some tasks, which may be a software application that can be executed in parallel by executing the tasks of the application in parallel.

At block 1004, the one or more tasks may be executed on the two or more processing elements. For example, if only a subset of the processing engines 120 on a processing device 102 are assigned tasks to execute, then the tasks may be executed on the subset of the processing engines 120.

At block 1006, buffers associated with the two or more processing elements may be monitored. The monitored buffers may be used to communicate the one or more tasks to the two or more processing elements. As described herein, each processing element of a processing device 102 may have a buffer associated with it for receiving and sending data (including program code and information upon which the program code operate). The processing device 102 may implement an event mechanism (including but not limited to, event registers, timing registers, programmable registers to hold time thresholds) to indicate whether certain activities have occurred. At block 1008, states of the two or more processing elements may be determined based on the monitored buffer activities. For example, whether a processing engine 120 is in an idle state may be determined based on whether a buffer associated with the processing engine 120 has been idle for a certain amount of time. At block 1010, a first event flag may be set after no activity is monitored in at least one of the two or more processing elements based on the determined states. Continuing with the preceding example, an event flag may be set after there is no activity is monitored for the processing engine 120 based on the monitored buffer associated with the processing engine 120 having no activity for the certain amount of time.

One example of computing system 100 configured to execute the exemplary process 1100 may be the computing system 100C, in which the host 11 and other components of the computing system 100C, such as but not limited to, one or more of the processing engines 120, clusters 110, super clusters 130 and the processing devices 102, may be configured through hardware, firmware, and/or software to be specifically designed for execution of one or more of the operations of exemplary process 1100.

The exemplary process 1100 may start with block 1102, one or more tasks may be assigned to at least a subset of processing elements of a plurality of processing devices in a computing system. For example, the exemplary system 100C may comprise hundreds of processing devices 102 and each may comprise hundreds of processing engines. A computer application to be executed by the computing system 100C may have only a couple of tasks to be assigned to two processing engines for parallel processing and the host 11 may assign the couple of tasks to two processing engines, such as the processing engines 120A and 120B shown on FIG. 7 or 8. At block 1104, the one or more tasks may be loaded to the assigned processing elements. Continuing with the preceding example, the couple of tasks assigned to the processing engines 120A and 120B may be loaded to the processing engines 120A and 120B.

At block 1106, the one or more tasks may be executed on the assigned processing elements. For example, the couple of tasks assigned to the processing engines 120A and 120B may be executed on the processing engines 120A and 120B. At block 1108, buffers associated with the assigned processing elements may be monitored and the monitored buffers may be used to communicate the one or more tasks to the two or more processing elements. In one embodiment, the host 11 may load the assigned tasks to the processing engines 120A and 120B. As described herein, the loading may include sending data to the processing device 102 and via the routers 104, 134 (if super clusters are implemented) and 112. Each processing element, such as the processing engines 120A and 120B, of a processing device 102 may have a buffer associated with it for receiving and sending data (including program code and information upon which the program code operate). The processing device 102 may implement an event mechanism (including but not limited to, event registers, timing registers, programmable registers to hold time thresholds) to indicate whether certain activities have occurred.

At block 1110, states of the assigned processing elements may be determined based on the monitored buffer activities. For example, whether a processing engine 120 is in an idle state may be determined based on whether a buffer associated with the processing engine 120 has been idle for a certain amount of time. In one embodiment, the states may be determined at the host 11, the processing device 102, the cluster 110, and/or another processing engine (inside the same cluster 102 or anywhere within the computing system 100C).

At block 1112, a first event flag may be set after no activity is monitored in at least one of the two or more processing elements based on the determined states. For example, an event flag may be set after there is no activity is monitored for a processing engine 120 based on the monitored buffer 225 associated with the processing engine 120 having no activity for the certain amount of time.

It should be noted that some of the operations of processes 1000 and 1100 may be similar because operating a computing system 100 for parallel processing includes identical and/or similar features as operating a processing device 102 for parallel processing. In those operations, the description with respect to one operation in one of the processes 1000 and 1100 may be applicable to the corresponding operation in the other process as well.

By virtue of the synchronization mechanisms described in this disclosure, a computing system that supports parallel processing may be more easily configured, partitioned, and/or load-balanced while maintaining functionally correct interoperation between multiple computing resources of the computing system. Non-exclusive examples of computing resources may include processing engines, clusters, super clusters, and/or processing devices. It should be noted that not all computing resources, for example, device controllers, routers, memory controllers, etc., will actually execute program code of computation tasks, but these computing resources may be configured to facilitate the processing engines to coordinate, cooperate and execute program code of computation tasks and they may also be configured to generate event signals to indicate occurrence of events within the respective computing resource.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. A processing device, comprising:
a plurality of processing elements each configured to generate events;
a plurality of buffers for communicating data to and from the plurality of processing elements;
at least one programmable register to hold a predefined time limit;
at least one timing register for counting a time since a last activity in one or more buffers; and
at least one event register to hold an event flag, wherein the event flag is set to a signaled state to signal that an event has taken place when the time counted in the at least one timing register reaches the predefined time limit.

2. The processing device of claim 1, wherein the processing elements are processing engines and grouped into clusters, and the at least one event register comprises a plurality of event registers to hold at least one event flag associated with each cluster.

3. The processing device of claim 1, wherein the at least one event flag is associated with the processing device as a whole.

4. The processing device of claim 1, wherein the event flag is automatically reset to a non-signaled state in response to a processing element taking an action in response to the signaled state of the event flag.

5. The processing device of claim 1, wherein at least one processing element is configured to change from a sleep state to an executing state based on the event being signaled.

6. A method of operating a processing device that has a plurality processing elements configured to support parallel processing, comprising:
loading one or more tasks to be executed in two or more processing elements of the plurality of processing elements;
executing one or more tasks on the two or more processing elements;
monitoring buffers associated with the two or more processing elements, wherein the monitored buffers are used to communicate the one or more tasks to the two or more processing elements;
determining states of the two or more processing elements based on the monitored buffer activities; and
setting a first event flag after no activity is monitored in at least one of the two or more processing elements based on the determined states.

7. The method of claim 6, wherein at least one processing element is changed from a sleep state to an executing state based on the event flag being set.

8. The method of claim 6, wherein the one or more tasks form an application.

9. The method of claim 6, further comprising:
starting a timer when a specified subset of the plurality of processing elements all enter a predetermined state,
setting a second event flag if all the specified subset of the processing elements maintain the specified state for a specified duration, and
resetting the timer if one or more of the specified subset of the processing elements exit the predetermined state.

10. The method of claim 9, wherein the first signal is generated responsive to a given buffer being inactive for a programmable amount of time.

11. A computing system, comprising:
a plurality of processing device, each processing device comprising:
a plurality of processing elements each configured to generate events;
a plurality of buffers for communicating data to and from the plurality of processing elements;
at least one programmable register to hold a predefined time limit;
at least one timing register for counting a time since a last activity in one or more buffers; and
at least one event register to hold an event flag, wherein the event flag is set to a signaled state to signal that an event has taken place when the time counted in the at least one timing register reaches the predefined time limit; and
a host, the host being configured to:
assign one or more tasks to at least a subset of processing elements of the plurality of processing devices;
load to one or more tasks to the assigned processing elements to be executed thereon;
monitor event flag(s) associated with the assigned processing elements; and
determine whether one or more processing devices of the plurality of processing devices have entered an idle state.

12. The computing system of claim 11, wherein the processing elements are processing engines and grouped into clusters on respective processing devices, and the at least one event register for each processing device comprises a plurality of event registers to hold at least one event flag associated with each cluster on the respective processing devices.

13. The computing system of claim 11, wherein the at least one event flag is associated with each processing device as a whole.

14. The computing system of claim 11, wherein the event flag is automatically reset to a non-signaled state in response to a processing element taking an action in response to the signaled state of the event flag.

15. The computing system of claim 11, wherein at least one processing element is configured to change from a sleep state to an executing state based on the event being signaled.

16. A method of operating a computing system that has a plurality processing devices and each processing device has a plurality of processing elements configured to support parallel processing, comprising:
assigning one or more tasks to at least a subset of processing elements of the plurality of processing devices;
loading one or more tasks to the assigned processing elements;
executing the one or more tasks on the assigned processing elements;
monitoring buffers associated with the assigned processing elements, wherein the monitored buffers are used to communicate the one or more tasks to the two or more processing elements;
determining states of the assigned processing elements based on the monitored buffer activities; and
setting a first event flag after no activity is monitored in at least one of the two or more processing elements based on the determined states.

17. The method of claim 16, wherein at least one processing element is changed from a sleep state to an executing state based on the event flag being set.

18. The method of claim 16, wherein the one or more tasks form an application.

19. The method of claim 16, further comprising:
starting a timer on a processing device when all processing elements of the specified subset of the plurality of processing elements on the processing device enter a predetermined state,
setting a second event flag on the processing device if all processing elements of the specified subset of the processing elements maintain the specified state for a specified duration, and
resetting the timer if one or more of the processing elements of the specified subset of the processing elements on the processing device exit the predetermined state.

20. The method of claim 19, wherein the first signal is generated responsive to a given buffer being inactive for a programmable amount of time.
